(19) United States
(12) Patent Application Publication
(10) Pub. No.: US 2026/0186646 A1
(43) Pub. Date: Jul. 2, 2026

(54) ELECTRONIC DEVICE AND OPERATION METHOD THEREOF

(71) Applicant: SAMSUNG ELECTRONICS CO., LTD., Suwon-si (KR)

(72) Inventors: Sangjin HAN, Suwon-si (KR); Nayoung KOH, Suwon-si (KR); Jooyoun KIM, Suwon-si (KR); Sugyeong HYEON, Suwon-si (KR)

(73) Assignee: SAMSUNG ELECTRONICS CO., LTD., Suwon-si (KR)

(21) Appl. No.: 19/547,154

(22) Filed: Feb. 23, 2026

Related U.S. Application Data
(63) Continuation of application No. PCT/KR2024/009640, filed on Jul. 8, 2024.

(30) Foreign Application Priority Data
Aug. 24, 2023 (KR) 10-2023-0111515

(51) Int. Cl. G06F 3/0486

(52) U.S. Cl. CPC G06F 3/0486

(57) ABSTRACT

An electronic device, including at least one processor, for multi-window control and an operation method thereof. The at least one processor configured to: detect an input for selecting, dragging, and dropping a first decorator corresponding to a first window group; according to a drop location of the first decorator being within a range of a second decorator, generate and display a third window group in which the first window group and the second window group are combined in an arrangement relative to each other based on structural characteristics of respective at least one window included in the first window group and a second window group. The at least one processor defines and displays a unified decorator configured to collectively control a plurality of windows included in the third window group, and a plurality of individual decorators configured to individually control the plurality of windows included in the third window group.

### CROSS-REFERENCE TO RELATED APPLICATION

This application is a continuation application, under 35 U.S.C. § 111(a), of international application No. PCT/KR2024/009640, filed Jul. 8, 2024, which claims priority under 35 U.S. C. § 119 to Korean Patent Application No. 10-2023-0111515, filed Aug. 24, 2023, the disclosures of which are incorporated herein by reference in their entireties.

### Technical Field

The present disclosure relates to an electronic device and an operation method thereof, and more particularly, to an electronic device for multi-window control and an operation method thereof.

### Background Art

As the amount of information has exponentially increased due to the development of internet technology today, the use of computers in daily life has increased, and users'desire to use computers more easily and efficiently has increased. Computer operating systems used by users mostly provide services to users by using window-based application programs. Information is visually displayed on a display screen through a window, and users can access application programs through an interface with the window to visually obtain information.

In particular, in recent years, computer operating systems have supported a multi-window mode in response to the increasing size of displays and the need for multitasking. The multi-window mode is a screen-splitting function that allows two or more windows to be shared on the same screen when two or more applications are used simultaneously. When using various electronic devices, including smartphones, tablet PCs, and electronic whiteboards, users can use the multi-window mode to display two or more applications in separate windows and share the windows on a display.

In the multi-window mode, users need to adjust two or more windows to a desired size or move the windows to a desired location in order to arrange the windows on the display in a desired arrangement for efficient task performance. In the related art, users can configure a desired window arrangement in the multi-window mode by individually moving two or more displayed windows through mouse interaction or touch, and individually adjusting the sizes of two or more windows. Users have to perform multiple mouse interactions or touches to control two or more windows as desired, and thus experience time-wasting and inconvenience.

Therefore, to improve users'experience of using the multi-window mode, research has been conducted on a technology to automatically arrange two or more displayed windows in various arrangements and efficiently control two or more windows simultaneously.

### DISCLOSURE OF INVENTION

### Technical Problem

An electronic device according to an embodiment of the present disclosure includes a display, an input interface, a memory to store one or more instructions, and at least one processor configured to execute the one or more instructions stored in the memory. The processor detects an input, received through the input interface, for selecting, dragging, and dropping a first decorator corresponding to a first window group including at least one window. The processor identifies whether a drop location of the first decorator, which indicates a location at which the first decorator is dropped, is within a range of a second decorator corresponding to a second window group including at least one window. According to the drop location of the first decorator being identified as being within the range of the second decorator, the processor generates and displays a third window group in which the first window group and the second window group are combined in an arrangement relative to each other based on at least one of the drop location of the first decorator, structural characteristics of the at least one window included in the first window group, and structural characteristics of the at least one window included in the second window group. The processor defines and displays a unified decorator configured to collectively control a plurality of windows including the at least one window of the first window group and the at least one window of the second window group included in the third window group, and a plurality of individual decorators configured to individually control the plurality of windows included in the third window group.

An operation method of an electronic device according to an embodiment of the present disclosure includes detecting an input for selecting, dragging, and dropping a first decorator corresponding to a first window group including at least one window. The operation method of the electronic device includes identifying whether a drop location of the first decorator, which indicates a location at which the first decorator is dropped, is within a range of a second decorator corresponding to a second window group including at least one window. The operation method of the electronic device includes, according to the drop location of the first decorator being identified as being within the range of the second decorator, generating and displaying a third window group in which the first window group and the second window group are combined in an arrangement relative to each other based on at least one of the drop location of the first decorator, structural characteristics of the at least one window included in the first window group, and structural characteristics of the at least one window included in the second window group. The operation method of the electronic device includes defining and displaying a unified decorator configured to collectively control a plurality of windows including the at least one window of the first window group and the at least one window of the second window group included in the third window group, and a plurality of individual decorators configured to individually control the plurality of windows included in the third window group.

An embodiment of the present disclosure may provide a non-transitory computer-readable recording medium having recorded thereon a program for executing, on a computer, at least one of the embodiments of the method disclosed herein as a technical means for solving the above-described technical problems.

Other technical features will be readily apparent to one of ordinary skill in the art from the following drawings, descriptions, and claims.

### BRIEF DESCRIPTION OF DRAWINGS

FIG. 1A is a diagram illustrating examples of configurations and decorators of multiple windows before being combined, according to an embodiment.

FIG. 1B is a diagram illustrating examples of a configuration and a decorator of a combined multi-window, according to an embodiment.

FIG. 2 is a flowchart illustrating an operation method for multi-window control of an electronic device, according to an embodiment.

FIG. 3 is a diagram illustrating an example of a process, performed by an electronic device, of combining multiple windows based on structural characteristics of the windows, according to an embodiment.

FIG. 4A is a diagram illustrating an example of a process, performed by an electronic device, of combining multiple windows based on structural characteristics of the windows, according to an embodiment.

FIG. 4B is a diagram illustrating an example of a process, performed by an electronic device, of combining multiple windows based on structural characteristics of the windows, according to an embodiment.

FIG. 5A is a diagram illustrating an example of a process, performed by an electronic device, of combining a combined multi-window with an additional window based on structural characteristics of the windows, according to an embodiment.

FIG. 5B is a diagram illustrating an example of a process, performed by an electronic device, of combining a combined multi-window with an additional window based on structural characteristics of the windows, according to an embodiment.

FIG. 5C is a diagram illustrating an example of a process, performed by an electronic device, of combining a combined multi-window with an additional window based on structural characteristics of the windows, according to an embodiment.

FIG. 6A is a diagram illustrating an example of a process, performed by an electronic device, of combining a combined multi-window with an additional window based on structural characteristics of the windows, according to an embodiment.

FIG. 6B is a diagram illustrating an example of a process, performed by an electronic device, of combining a combined multi-window with an additional window based on structural characteristics of the windows, according to an embodiment.

FIG. 7 is a diagram illustrating an example of a process, performed by an electronic device, of combining a combined multi-window with an additional window based on structural characteristics of the windows, according to an embodiment.

FIG. 8 is a diagram illustrating an example of a process, performed by an electronic device, of combining a combined multi-window with an additional combined multi-window based on structural characteristics of the windows, according to an embodiment.

FIG. 9 is a diagram illustrating an example of a process, performed by an electronic device, of combining a combined multi-window with an additional combined multi-window based on structural characteristics of the windows, according to an embodiment.

FIG. 10 is a diagram illustrating an example of a process, performed by an electronic device, of combining a combined multi-window with an additional combined multi-window based on structural characteristics of the windows, so as to form a spectrum structure, according to an embodiment.

FIG. 11 is a diagram illustrating an example of a process, performed by an electronic device, of simply moving multiple windows without combining the windows, according to an embodiment.

FIG. 12A is a diagram illustrating an example of a process, performed by an electronic device, of controlling a combined multi-window collectively, according to an embodiment.

FIG. 12B is a diagram illustrating an example of a process, performed by an electronic device, of controlling a combined multi-window collectively, according to an embodiment.

FIG. 12C is a diagram illustrating an example of a process, performed by an electronic device, of controlling a combined multi-window collectively, according to an embodiment.

FIG. 13A is a diagram illustrating an example of a process, performed by an electronic device, of controlling a combined multi-window having a spectrum structure, according to an embodiment.

FIG. 13B is a diagram illustrating an example of a process, performed by an electronic device, of controlling a combined multi-window having a spectrum structure, according to an embodiment.

FIG. 14A is a diagram illustrating an example of a process, performed by an electronic device, of individually controlling multiple windows that have been combined, according to an embodiment.

FIG. 14B is a diagram illustrating an example of a process, performed by an electronic device, of individually controlling multiple windows that have been combined, according to an embodiment.

FIG. 14C is a diagram illustrating an example of a process, performed by an electronic device, of individually controlling multiple windows that have been combined, according to an embodiment.

FIG. 15A is a diagram illustrating an example a process, performed by an electronic device, of controlling a combined multi-window by using a grid view button, according to an embodiment.

FIG. 15B is a diagram illustrating an example a process, performed by an electronic device, of controlling a combined multi-window having a spectrum structure by using a grid view button, according to an embodiment.

FIG. 16 is a diagram illustrating an example a process, performed by an electronic device, of controlling a combined multi-window by using a playback button, according to an embodiment.

FIG. 17A is a diagram illustrating an example of a process, performed by an electronic device supporting a multi-input processing function, of combining multiple windows, according to an embodiment.

FIG. 17B is a diagram illustrating an example of a process, performed by an electronic device supporting a multi-input processing function, of combining multiple windows, according to an embodiment.

FIG. 17C is a diagram illustrating an example of a process, performed by an electronic device supporting a multi-input processing function, of separating a combined multi-window, according to an embodiment.

FIG. 18 is a block diagram of an electronic device according to an embodiment.

FIG. 19 is a block diagram of an electronic device according to an embodiment.

### MODE FOR THE INVENTION

The terms used herein are described as general terms currently used in consideration of functions described in the present disclosure, but the terms may have different meanings according to the intention of one of ordinary skill in the art, precedent cases, or the appearance of new technologies. In certain cases, there are terms arbitrarily selected by the applicant, and in such cases, the meanings thereof will be described in detail in the relevant description section. Accordingly, the terms used herein should be defined not based on the names thereof but based on the meanings thereof and the whole context of the present disclosure.

Also, the terms used herein are merely used to describe certain embodiments and are not intended to be limiting of the present disclosure.

A singular expression may include a plural expression unless the context clearly indicates otherwise. The terms used herein, including technical or scientific terms, may have the same meanings as commonly understood by one of ordinary skill in the art.

In the specification, when a part “includes” a component, the part may additionally include other components rather than excluding other components, unless explicitly stated otherwise. Also, the term “. . . unit” or “. . . module” as used herein refers to a unit that processes at least one function or operation, which may be implemented as hardware or software, or may be implemented as a combination of hardware and software.

Also, each component described below may additionally perform, in addition to its own main functions, some or all of the functions performed by other components, and some of the main functions performed by each component may be performed exclusively by other components.

The expression “configured to” as used herein may be used interchangeably with, for example, “suitable for,” “having the capacity to,” “designed to,” “adapted to,” “made to,” or “capable of,” depending on the context.

The expression “configured to” may not necessarily refer to “specifically designed to” in hardware. Instead, in some contexts, the expression “a system configured to” may indicate that the system, together with other devices or components, is “capable of” doing something.

In the specification, when a component is “connected” or “joined” to another component, the component may be directly connected or joined to the other component, but the components may also be connected or coupled via another intervening component, unless explicitly stated otherwise. In the specification, when a part is “connected” to another part, the part may not only be “directly connected” to the other part, but may also be “electrically connected” to the other part with another element therebetween.

As used herein, and particularly in the claims, the definite article “the” and similar referents may refer to both singular and plural forms. Also, unless there is a description explicitly specifying the order of operations describing a method according to the present disclosure, the operations may be performed in an appropriate order. The present disclosure is not, however, limited to the described order of the operations.

The expression “in some embodiments” or “in an embodiment” used throughout the specification does not always indicate the same embodiment.

Some embodiments of the present disclosure may be represented by functional block configurations and various processing operations. Some or all of the functional blocks may be implemented by various numbers of hardware and/or software components configured to perform certain functions. For example, the functional blocks of the present disclosure may be implemented by one or more microprocessors or circuit components for certain functions. Also, for example, the functional blocks of the present disclosure may be implemented using various programming or scripting languages. The functional blocks may be implemented using algorithms executed by one or more processors. Also, the present disclosure may employ general techniques for electronic environment setting, signal processing, and/or data processing.

In the drawings, parts irrelevant to the description are omitted in order to clearly describe the present disclosure, and like reference numerals designate like components throughout the specification. Also, the reference numerals used in each drawing are only intended to describe each drawing, and different reference numerals used in different drawings are not intended to indicate different components. Also, connection lines or connection members between components shown in the drawings merely illustrate examples of functional connections and/or physical or circuit connections. In an actual device, connections between components may be represented by various functional connections, physical connections, or circuit connections that are replaceable or added.

In describing embodiments, when it is determined that a detailed description of a related known technology may unnecessarily obscure the gist of the present disclosure, the detailed description thereof is omitted. Also, the expression “at least one of a, b, or c” as used herein may refer to “a,” “b,” “c,” “a and b,” “a and c,” “b and c,” “all of a, b, and c,” or variations thereof. The numbers used in the description of the specification (e.g., first, second, third, etc.) are merely identifiers to distinguish one component from another component.

Hereinafter, embodiments of the present disclosure will be described in detail with reference to the accompanying drawings to allow one of ordinary skill in the art to easily carry out the embodiments. The present disclosure may, however, be embodied in many different forms and should not be construed as being limited to the embodiments set forth herein.

In the present disclosure, a ‘user’ refers to a person who uses an electronic device, and may include a consumer, an evaluator, a viewer, an administrator, or an installer. In particular, the user may include a user of a multi-window mode.

In the present disclosure, a ‘window’ refers to a frame that represents an application currently being used by the user on a computer screen/display. One application may correspond to one window, and the user may visually recognize, through a window, a corresponding application on the computer screen/display. A ‘window group’ refers to a collection of windows, and may include one window or a plurality of windows.

In the present disclosure, a ‘multi-window’ refers to two or more windows. A ‘multi-window mode’ refers to a screen-splitting function that allows a multi-window to be displayed on the computer screen/display. The user may use the multi-window mode to use two or more applications simultaneously.

In the present disclosure, ‘to control windows’ indicates that the electronic device configures windows displayed on the display into a visual state/layout/arrangement desired by the user through interaction with the user, such as moving the windows displayed on the display to a location desired by the user, or adjusting the windows displayed on the display to a size desired by the user.

In the present disclosure, ‘to combine windows’ indicates that the electronic device associates windows included in a multi-window with each other, so that a plurality of windows are visually displayed as being combined on the display and configured in a relationship that allows for unified control.

In the present disclosure, a ‘decorator’ refers to a visual tool displayed on the display to control a window corresponding to/associated with the decorator, and may be expressed as a ‘title bar,’ a ‘tool bar,’ or a ‘window identifier/indicator.’ The decorator may include one or more buttons or items for performing various functions to control the window. The decorator may be involved in allowing the electronic device to combine the window corresponding to/associated with the decorator with another window, or to determine a shape of a combined multi-window that includes the window corresponding to/associated with the decorator.

In the present disclosure, a ‘first decorator’ refers to one of decorators corresponding to/associated with a first window group, and a ‘second decorator’ refers to one of decorators corresponding to/associated with a second window group.

The present disclosure aims to improve a user's experience of using a multi-window mode by providing a method, performed by an electronic device, of controlling a multi-window by using a decorator.

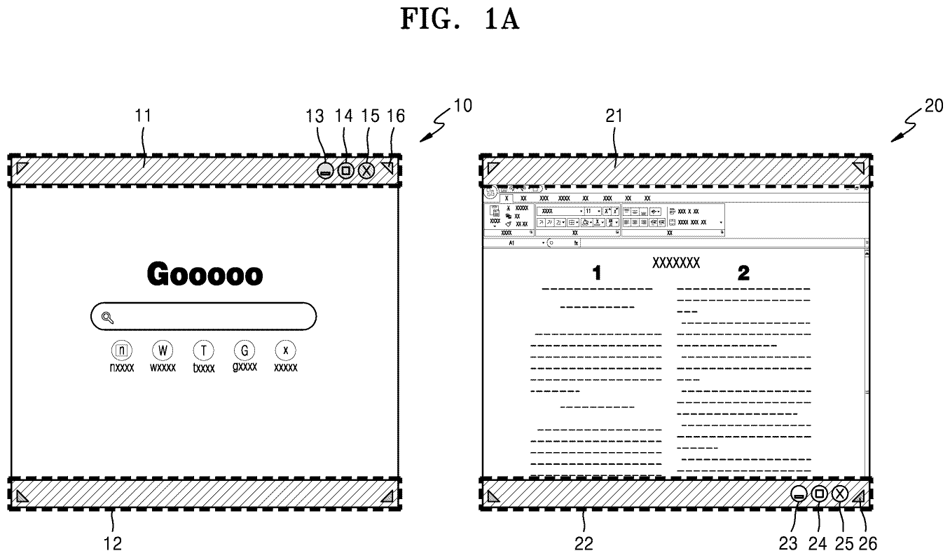

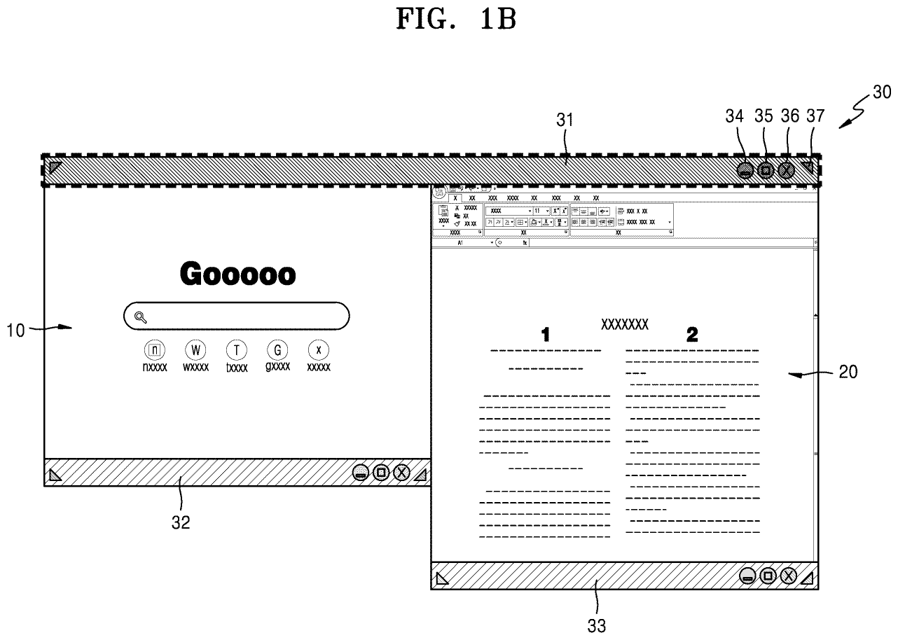

FIG. 1A is a diagram illustrating examples of configurations and decorators of multiple windows before being combined, according to an embodiment.

Referring to FIG. 1A, an electronic device may display a first window 10 and a second window 20 on a display. In a multi-window mode, a user may use two or more applications simultaneously through the first window 10 and the second window 20.

According to an embodiment, the first window 10 may include a first decorator at an upper end thereof, a lower end thereof, or upper and lower ends thereof. The first decorator may correspond to/be associated with the first window 10, and may refer to a visual tool displayed on the display to control the first window 10. For example, in FIG. 1A, the first decorator may include/correspond to/refer to a decorator 11 located at the upper end of the first window 10 and a decorator 12 located at the lower end of the first window 10.

The first decorators 11 and 12 may include one or more buttons or items for performing various functions to control the first window 10. The one or more buttons or items may include, for example, a minimize button 13, a maximize button 14, a close button 15, and a resize button 16, but are not limited thereto.

According to an embodiment, the resize button 16 may be included in both the decorator 11 located at the upper end of the first window 10 and the decorator 12 located at the lower end of the first window 10. According to an embodiment, the minimize button 13, the maximize button 14, and the close button 15 may be included only in either the decorator 11 located at the upper end of the first window 10 or the decorator 12 located at the lower end of the first window 10.

The first decorators 11 and 12 may be involved in allowing the electronic device to combine the first window 10 with another window, or in allowing the electronic device to determine a shape of a combined multi-window including the first window 10.

Similarly, the second window 20 may include a second decorator at an upper end thereof, a lower end thereof, or upper and lower ends thereof. The second decorator may correspond to/be associated with the second window 20, and may refer to a visual tool displayed on the display to control the second window 20. For example, in FIG. 1A, the second decorator may include/correspond to/refer to a decorator 21 located at the upper end of the second window 20 and a decorator 22 located at the lower end of the second window 20.

The second decorators 21 and 22 may include one or more buttons or items for performing various functions to control the second window 20. The one or more buttons or items may include, for example, a minimize button 23, a maximize button 24, a close button 25, and a resize button 26, but are not limited thereto.

According to an embodiment, the resize button 26 may be included in both the decorator 21 located at the upper end of the second window 20 and the decorator 22 located at the lower end of the second window 20. According to an embodiment, the minimize button 23, the maximize button 24, and the close button 25 may be included only in either the decorator 21 located at the upper end of the second window 20 or the decorator 22 located at the lower end of the second window 20.

The second decorators 21 and 22 may be involved in allowing the electronic device to combine the second window 20 with another window, or in allowing the electronic device to determine a shape of a combined multi-window including the second window 20.

FIG. 1B is a diagram illustrating examples of a configuration and a decorator of a combined multi-window, according to an embodiment.

Referring to FIG. 1B, the electronic device may detect an input for selecting, dragging, and dropping a first decorator corresponding to the first window 10, and may identify whether a location at which the first decorator is dropped is within a range of a second decorator corresponding to the second window 20. When the drop location of the first decorator is identified as being within the range of the second decorator, the electronic device may generate and display, based on the drop location of the first decorator or structural characteristics of each of the windows 10 and 20, a third window group 30 in which the first window 10 and the second window 20 are combined. The electronic device 100 may define and display a unified decorator for collectively controlling the plurality of windows 10 and 20 included in the third window group 30, and a plurality of individual decorators for individually controlling the plurality of windows 10 and 20 included in the third window group 30.

The third window group 30 may be generated by combining the first window 10 with the second window 20. The third window group 30 may include the first window 10 and the second window 20. Due to the combination, the first window 10 and the second window 20 may be associated with each other, may be visually displayed as being combined on the display, and may be configured in a relationship that allows for unified control.

According to an embodiment, a size of each of the first window 10 and the second window 20 included in the third window group 30 may be the same as before being combined. The term ‘size’ refers to an area occupied by a corresponding window within the display.

According to an embodiment, a location/arrangement/layout of each of the first window 10 and the second window 20 within the display may vary due to the combination. The term ‘location’ refers to a point at which a specific object is located within the display, and may be expressed as vector value coordinates (x, y, z). The term ‘arrangement/layout’ refers to a state in which a plurality of windows are arranged within the display.

According to an embodiment, a unified decorator 31 may be defined to collectively control the plurality of windows 10 and 20 included in the third window group 30 due to the combination of the first window 10 and the second window 20.

The unified decorator 31 may correspond to/be associated with all of the plurality of windows 10 and 20 included in the third window group 30 to collectively control the third window group 30. The unified decorator 31 may include one or more buttons or items for performing various functions to collectively control the third window group 30 (i.e., the plurality of windows 10 and 20 included in the third window group 30). The one or more buttons or items may include, for example, a minimize button 34, a maximize button 35, a close button 36, and a resize button 37, but are not limited thereto.

According to an embodiment, a plurality of individual decorators may be defined to individually control the plurality of windows included in the third window group 30 due to the combination of the first window 10 and the second window 20.

For example, in FIG. 1B, the plurality of individual decorators may include/correspond to/refer to a decorator 32 and a decorator 33. Among the plurality of individual decorators 32 and 33, the decorator 32 may correspond to/be associated with the first window 10 to individually control the first window 10 included in the third window group 30. Among the plurality of individual decorators, the decorator 33 may correspond to/be associated with the second window 20 to individually control the second window 20 included in the third window group 30. Each of the plurality of individual decorators 32 and 33 may include one or more buttons or items for performing various functions to individually control each of the plurality of windows 10 and 20 included in the third window group 30.

According to an embodiment, the unified decorator 31 may be distinguished from the plurality of individual decorators 32 and 33 in a visually identifiable manner (e.g., color, pattern, etc.).

In FIGS. 1A and 1B, for convenience of description, the first window 10 and the second window 20 are illustrated as one window, but may each be a window group including a plurality of windows.

The present disclosure aims to improve a user's experience of using a multi-window mode by providing a method, performed by an electronic device, of controlling a multi-window by using a decorator.

Hereinafter, a process, performed by an electronic device according to an embodiment of the present disclosure, of combining multiple windows by using a decorator will be described in detail.

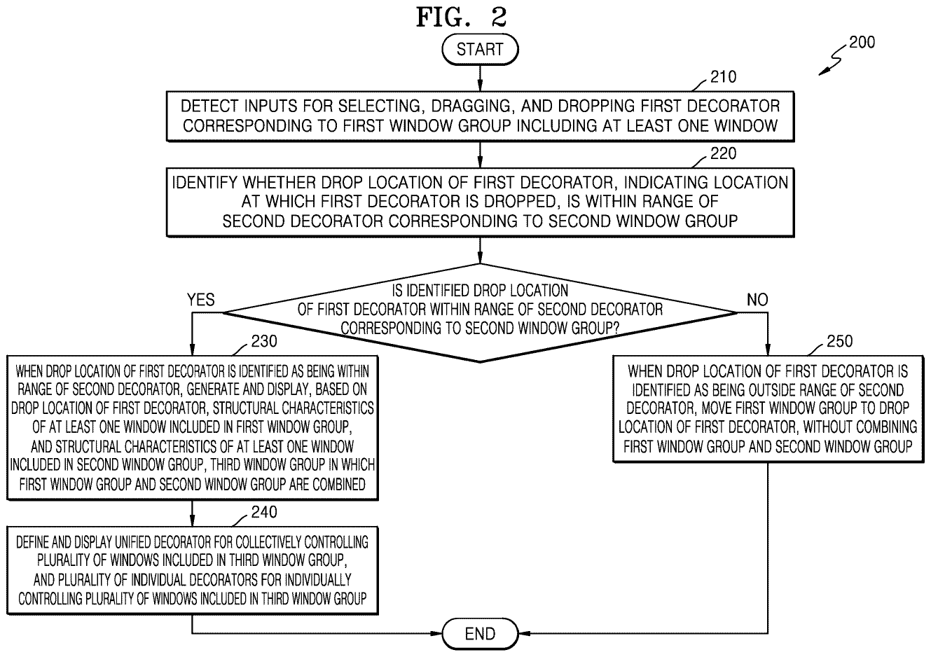

FIG. 2 is a flowchart illustrating an operation method 200 for multi-window control of an electronic device, according to an embodiment.

Referring to FIG. 2, in operation 210, the electronic device may detect an input for selecting, dragging, and dropping a first decorator corresponding to a first window group. The first window group may include at least one window.

The electronic device may receive and detect the input for selecting, dragging, and dropping the first decorator through an input interface.

A ‘selecting’ input may, for example, refer to a signal generated when a user clicks on a specific object displayed on a display by using a mouse, or touches the display by using a body part. The electronic device may process an input for selecting a location included within a range of the first decorator as an input for selecting the first decorator.

A ‘dragging’ input may, for example, refer to a signal generated when the user moves a mouse or body part from one point to another point after a selecting input has occurred. A ‘dropping’ input may, for example, refer to a signal generated when the user releases a click by using a mouse or releases a touch by using a body part after a selecting or dragging input has occurred.

In operation 220, the electronic device may identify whether a drop location of the first decorator, which indicates a location at which the first decorator is dropped, is within a range of a second decorator corresponding to a second window group. The second window group may include at least one window.

The drop location of the first decorator indicates a location at which the first decorator is dropped on the display, and specifically, may be expressed as a vector value (x, y, z), that is, coordinates indicating a point at which the first decorator is dropped within the display. The range of the second decorator indicates a certain area range occupied by the second decorator on the display, and may be expressed as a set of vector values (x, y, z).

According to an embodiment, the electronic device may identify whether the drop location of the first decorator is within the range of the second decorator corresponding to the second window group by determining whether the vector value of the point at which the first decorator is dropped is included in the set of vector values indicating the range of the second decorator.

In operation 230, when the drop location of the first decorator is identified as being within the range of the second decorator, the electronic device may generate, based on at least one of the drop location of the first decorator, the structural characteristics of the at least one window included in the first window group, and the structural characteristics of the at least one window included in the second window group, a third window group in which the first window group and the second window group are combined, and may display the third window group on the display.

According to an embodiment, when the vector value of the point at which the first decorator is dropped is included in the set of vector values indicating the range of the second decorator, the electronic device may identify that the drop location of the first decorator is within the range of the second decorator corresponding to the second window group.

According to an embodiment, the electronic device may identify whether the drop location of the first decorator is included on a left side or a right side of a central portion within the range of the second decorator. The electronic device may determine, based on a result of the identifying, an arrangement/layout of a plurality of windows included in the third window group.

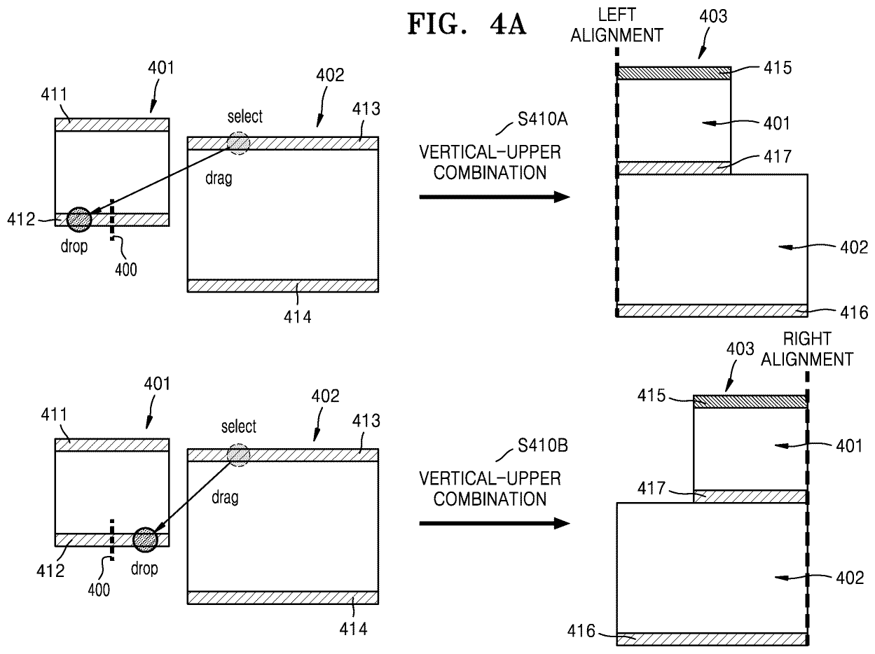

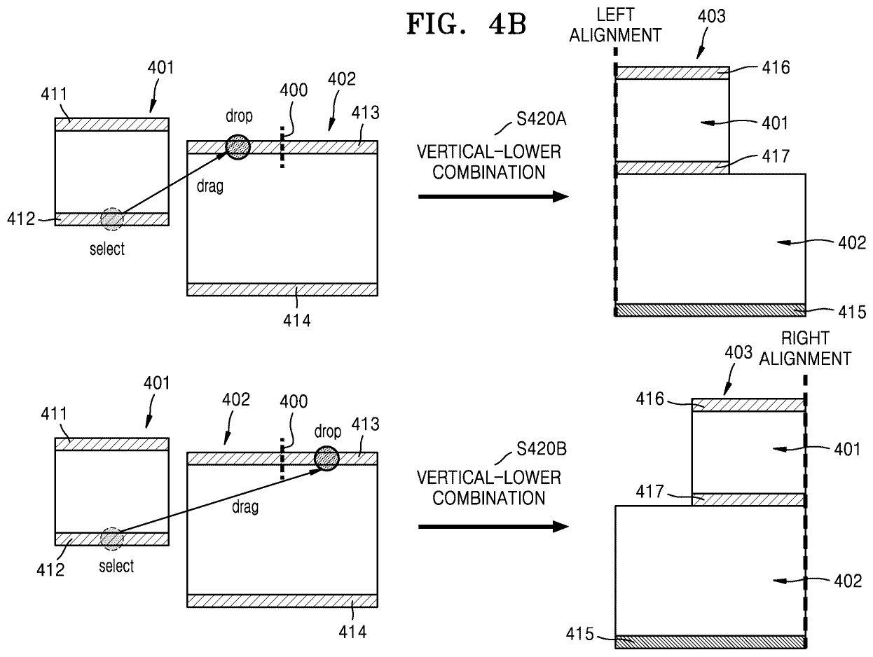

The central portion within the range of the second decorator refers to a point located at the exact center of an x-axis direction range of the second decorator (e.g., 400 of FIG. 4A). In an example, the electronic device may determine, based on the result of the identifying, whether to left-align or right-align the arrangement/layout of the plurality of windows included in the third window group. In an example, when there are three or more windows included in the third window group, the electronic device may determine an arrangement/layout order of the windows based on the result of the identifying.

According to an embodiment, structural characteristics of a window may include a location of a decorator corresponding to/associated with the window within the window, but are not limited thereto, and may include all structural characteristics of the window that may be visually recognized. The location of the decorator corresponding to/associated with the window may be at an upper end or a lower end of the window.

For example, the structural characteristics of the at least one window included in the first window group may include a location of the first decorator within the first window group. For example, in FIG. 1A, a location of the decorator 11 within the first window 10 may be at the upper end of the first window 10, and a location of the decorator 12 within the first window 10 may be at the lower end of the first window 10.

Similarly, the structural characteristics of the at least one window included in the second window group may include a location of the second decorator within the second window group. For example, in FIG. 1A, a location of the decorator 21 within the second window 20 may be at the upper end of the second window 20, and a location of the decorator 22 within the second window 20 may be at the lower end of the second window 20.

According to an embodiment, the electronic device may determine, depending on whether the location of the first decorator within the first window group is at the upper end or the lower end, and on whether the location of the second decorator within the second window group is at the upper end or the lower end, a shape of the third window group, a location of the unified decorator, and locations of the plurality of individual decorators.

According to an embodiment, structural characteristics of a window may include a shape of the window, but are not limited thereto, and may include all structural characteristics of the window that may be visually recognized.

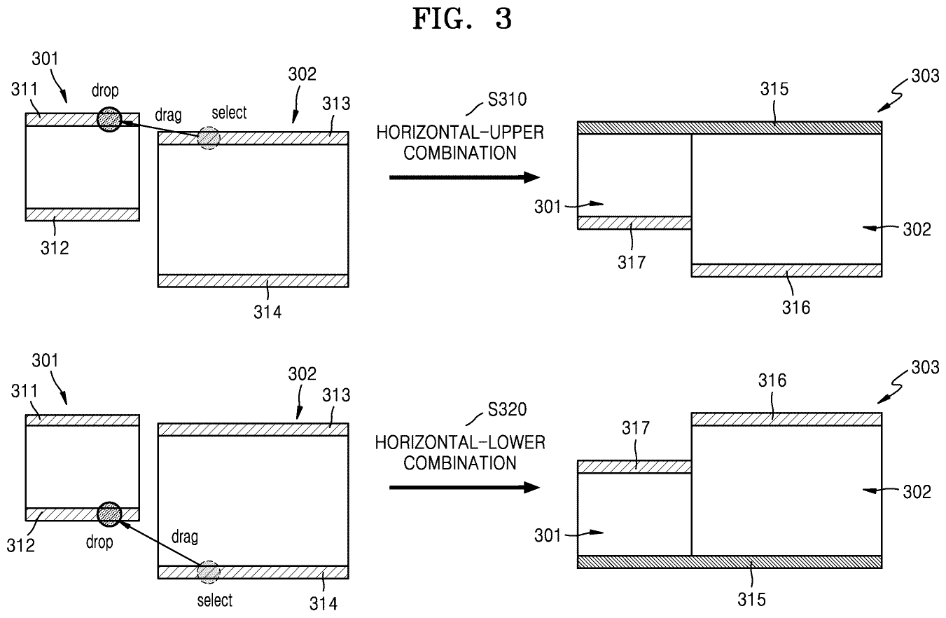

The shape of the window refers to a visually recognizable form of the window, and may include, when the window is a multi-window, an arrangement/layout of a plurality of windows included in the multi-window. For example, an arrangement or layout of a multi-window may include a horizontal shape, a vertical shape, a complex shape, and a spectrum shape, and examples of each shape will be described in detail below with reference to the drawings (FIGS. 3 to 10).

In operation 240, the electronic device may define and display a unified decorator for collectively controlling the plurality of windows included in the third window group, and a plurality of individual decorators for individually controlling the plurality of windows included in the third window group.

The electronic device may generate/define the unified decorator and the plurality of individual decorators and display the decorators on the display. The unified decorator and the plurality of individual decorators 32 and 33 may be displayed on the display so as to be included in the third window group, and in particular, the plurality of individual decorators may be displayed so as to be included in the first window group and the second window group corresponding thereto/associated therewith, respectively.

According to an embodiment, the electronic device may distinguish the unified decorator from the plurality of individual decorators in a visually identifiable manner (e.g., color, pattern, etc.).

According to an embodiment, the unified decorator may include one or more items for collectively controlling the plurality of windows included in the third window group. The unified decorator may be associated with all of the plurality of windows included in the third window group. That is, when the electronic device detects an input for selecting, dragging, and dropping the unified decorator itself or one or more items included in the unified decorator, processing of the input by the electronic device may affect all of the plurality of windows included in the third window group.

According to an embodiment, each of the plurality of individual decorators may include one or more items for individually controlling each of the plurality of windows included in the third window group. Each of the plurality of individual decorators may be associated with a corresponding window among the plurality of windows included in the third window group.

For example, in FIG. 1B, when the electronic device detects an input for selecting, dragging, and dropping the decorator 32 itself or one or more items included in the decorator 32, processing of the input by the electronic device may only affect the first window 10 corresponding to/associated with the decorator 32, and may not affect the second window 20. Similarly, when the electronic device detects an input for selecting, dragging, and dropping the decorator 33 itself or one or more items included in the decorator 33, processing of the input by the electronic device may only affect the second window corresponding to/associated with the decorator 33, and may not affect the first window 10.

According to an embodiment of the present disclosure, the electronic device may improve a user's experience of using a multi-window mode by providing a method of combining multiple windows by using a decorator and controlling the combined multi-window. The effects obtainable in the present disclosure are not limited to the above-mentioned effects, and other effects not mentioned may be clearly understood by one of ordinary skill in the art from the description below.

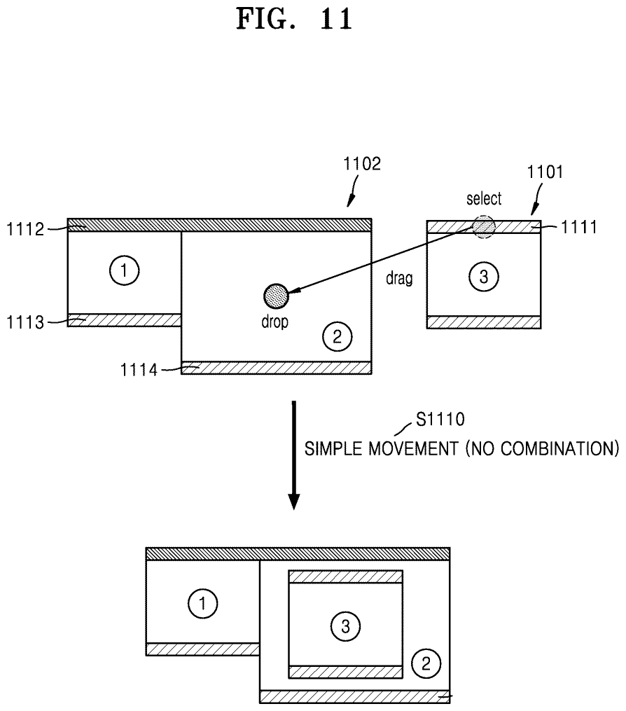

In operation 250, when the drop location of the first decorator is identified as being outside the range of the second decorator, the electronic device may move the first window group to the drop location of the first decorator, without combining the first window group and the second window group. The operation of the electronic device in operation 250 will be described in detail with reference to FIG. 11.

Hereinafter, specific examples of a process, performed by an electronic device according to an embodiment of the present disclosure, of combining multiple windows in various arrangements/combinations, based on drop locations of decorators or structural characteristics of respective windows corresponding to the decorators, will be described.

FIG. 3 is a diagram illustrating an example of a process, performed by an electronic device, of combining multiple windows based on structural characteristics of the windows, according to an embodiment. In particular, FIG. 3 illustrates a shape in which multiple windows are combined horizontally.

Referring to FIG. 3, a window 302 corresponds to the first window group of FIG. 2, a window 301 corresponds to the second window group of FIG. 2, and a window 303 corresponds to the third window group of FIG. 2. Decorators 311 and 312 correspond to the first decorator of FIG. 2, and decorators 313 and 314 correspond to the second decorator of FIG. 2. The electronic device of FIG. 3 may combine the first window group and the second window group according to the method disclosed in operations 210 to 240 of FIG. 2, wherein details redundant to those described in FIG. 2 will be understood by referring to FIG. 2, and a description thereof will be omitted.

In S310, the electronic device may configure a horizontal-upper combination of multiple windows. The horizontal-upper combination indicates a shape in which, when combining multiple windows, the multiple windows are arranged horizontally, and a unified decorator that is associated with the entire multi-window defined by the combination is located at an upper end of the combined multi-window.

Based on a location of the decorator 313 within the window 302 being at an upper end of the window 302, a drop location of the decorator 313 being within a range of the decorator 311, and a location of the decorator 311 within the window 301 being at an upper end of the window 301, the electronic device may determine a shape of the combined multi-window 303 as a horizontal-upper combination, may determine a location of a unified decorator 315 to be at an upper end of the window 303, and may locate individual decorators 316 and 317 at lower ends of the windows 302 and 301 corresponding thereto/associated therewith, respectively.

The unified decorator 315 may be associated with all of the plurality of windows 301 and 302 included in the window 303, and each of the plurality of individual decorators 316 and 317 may be associated with a corresponding window among the plurality of windows 301 and 302 included in the window 303.

In S320, the electronic device may configure a horizontal-lower combination. The horizontal-lower combination indicates a shape in which, when combining multiple windows, the multiple windows are arranged horizontally, and a decorator that is associated with the entire multi-window defined by the combination is located at a lower end of the combined multi-window.

Based on a location of the decorator 314 within the window 302 being at the lower end of the window 302, a drop location of the decorator 314 being within a range of the decorator 312, and a location of the decorator 312 within the window 301 being at the lower end of the window 301, the electronic device may determine the shape of the combined multi-window 303 as a horizontal-lower combination, may determine the location of the unified decorator 315 to be at a lower end of the window 303, and may locate the plurality of individual decorators 316 and 317 at the upper ends of the windows 302 and 301 corresponding thereto/associated therewith, respectively.

The unified decorator 315 may be associated with all of the plurality of windows 301 and 302 included in the window 303, and each of the plurality of individual decorators 316 and 317 may be associated with a corresponding window among the plurality of windows 301 and 302 included in the window 303.

FIGS. 4A and 4B are each a diagram illustrating an example of a process, performed by an electronic device, of combining multiple windows based on structural characteristics of the windows, according to an embodiment. In particular, FIGS. 4A and 4B illustrate a shape in which multiple windows are combined vertically.

Referring to FIGS. 4A and 4B, a window 402 corresponds to the first window group of FIG. 2, a window 401 corresponds to the second window group of FIG. 2, and a window 403 corresponds to the third window group of FIG. 2. Decorators 411 and 412 correspond to the first decorator of FIG. 2, and decorators 413 and 414 correspond to the second decorator of FIG. 2. The electronic device of FIGS. 4A and 4B may combine the first window group and the second window group according to the method disclosed in operations 210 to 240 of FIG. 2, wherein details redundant to those described in FIG. 2 will be understood by referring to FIG. 2, and a description thereof will be omitted.

Referring to FIG. 4A, the electronic device may configure a vertical-upper combination of multiple windows. The vertical-upper combination indicates a shape in which, when combining multiple windows, the multiple windows are arranged vertically, and a decorator that is associated with the entire multi-window defined by the combination is located at an upper end of the combined multi-window.

In S410A, based on a location of the decorator 413 within the window 402 being at an upper end of the window 402, a drop location of the decorator 413 being within a range of the decorator 412, and a location of the decorator 412 within the window 401 being at a lower end of the window 401, the electronic device may determine a shape of the combined multi-window 403 as a vertical-upper combination, may determine a location of a unified decorator 415 to be at an upper end of the window 403, and may locate a plurality of individual decorators 416 and 417 at lower ends of the windows 402 and 401 corresponding thereto/associated therewith, respectively.

When the drop location of the first decorator 413 is identified as being included on a left side of a central portion 400 of the range of the second decorator 412, the electronic device may determine an arrangement of the first window group 402 and the second window group 401 included in the third window group 403 to be left-aligned. The electronic device may display the first window group 402 and the second window group 401 included in the third window group 403 on the display according to the determined left-aligned arrangement.

The unified decorator 415 may be associated with all of the plurality of windows 401 and 402 included in the window 403, and each of the plurality of individual decorators 416 and 417 may be associated with a corresponding window among the plurality of windows 401 and 402 included in the window 403.

In S410B, when the drop location of the first decorator 413 is identified as being included on a right side of the central portion 400 of the range of the second decorator 412, the electronic device may determine the arrangement of the first window group 402 and the second window group 401 included in the third window group 403 to be right-aligned. The electronic device may display the first window group 402 and the second window group 401 included in the third window group 403 on the display according to the determined right-aligned arrangement.

Referring to FIG. 4B, the electronic device may configure a vertical-lower combination of multiple windows. The vertical-lower combination indicates a shape in which, when combining multiple windows, the multiple windows are arranged vertically, and a decorator that is associated with the entire multi-window defined by the combination is located at a lower end of the combined multi-window.

In S420A, based on the location of the decorator 412 within the window 401 being at the lower end of the window 401, and the location of the decorator 413 within the window 402 being at the upper end of the window 402, the electronic device may determine the shape of the combined multi-window 403 as a vertical-lower combination, may determine the location of the unified decorator 415 to be at a lower end of the window 403, and may locate the plurality of individual decorators 416 and 417 at upper ends of the windows 401 and 402 corresponding thereto/associated therewith, respectively.

The unified decorator 415 may be associated with all of the plurality of windows 401 and 402 included in the window 403, and each of the plurality of individual decorators 416 and 417 may be associated with a corresponding window among the plurality of windows 401 and 402 included in the window 403.

When a drop location of the first decorator 412 is identified as being included on a left side of a central portion 400 of a range of the second decorator 413, the electronic device may determine an arrangement of the first window group 402 and the second window group 401 included in the third window group 403 to be left-aligned. The electronic device may display the first window group 402 and the second window group 401 included in the third window group 403 on the display according to the determined left-aligned arrangement.

In S420B, when the drop location of the first decorator 412 is identified as being included on a right side of the central portion 400 of the range of the second decorator 413, the electronic device may determine the arrangement of the first window group 402 and the second window group 401 included in the third window group 403 to be right-aligned. The electronic device may display the first window group 402 and the second window group 401 included in the third window group 403 on the display according to the determined right-aligned arrangement.

According to an embodiment, the electronic device may detect an input for selecting, dragging, and dropping a first decorator corresponding to a first window group, and when a drop location of the first decorator is identified as being within a range of a second decorator corresponding to a second window group, the electronic device may generate a UI and temporarily display the UI on the display to allow the user to select a shape of a third window group.

In this case, the user may select a desired shape of the third window group from among shapes included in the UI. The electronic device may detect an input for selecting a shape of the third window group, and may determine the shape of the third window group based on the detected input. The electronic device may generate the third window group according to the determined shape of the third window group and display the third window group on the display.

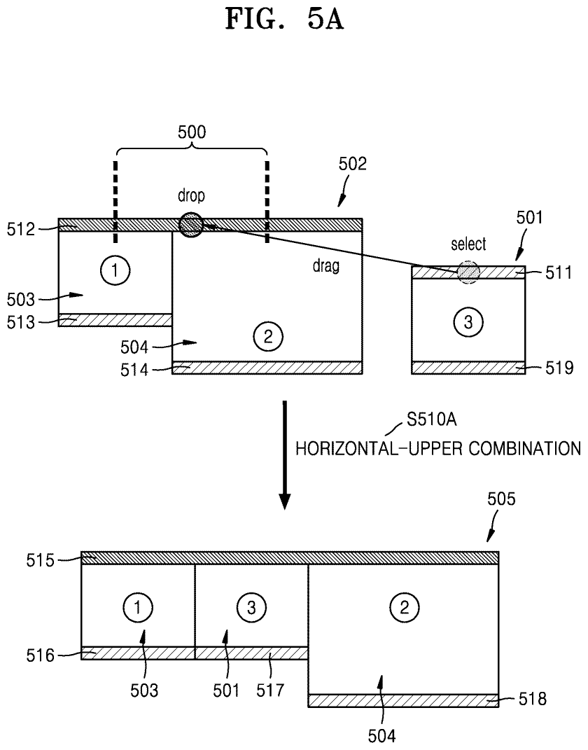

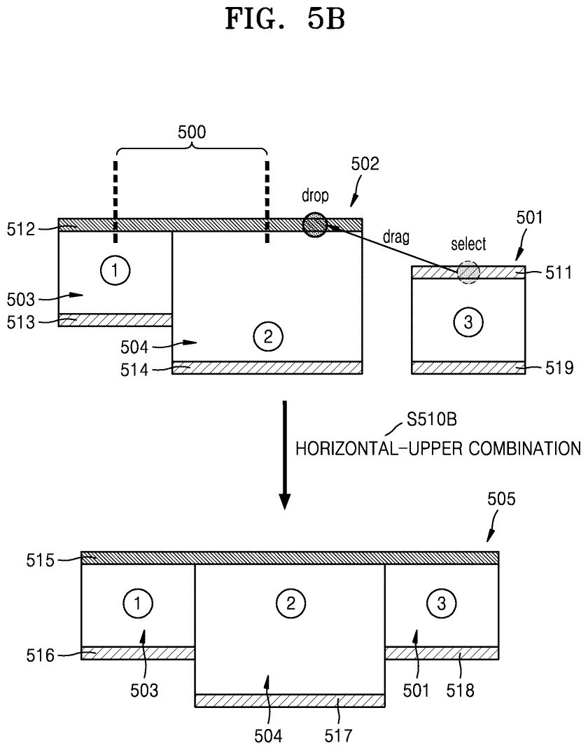

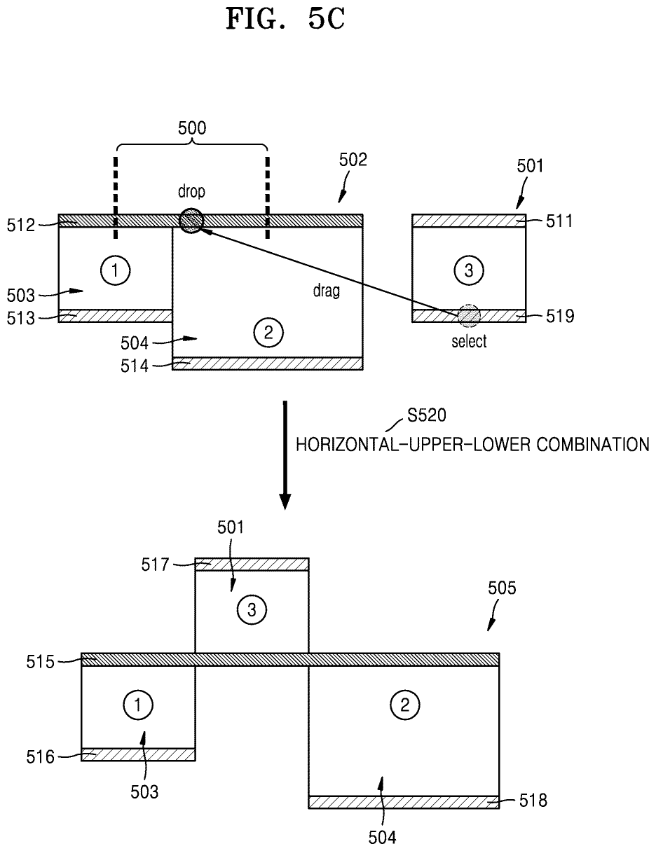

FIGS. 5A to 5C are each a diagram illustrating an example of a process, performed by an electronic device, of combining a combined multi-window with an additional window based on structural characteristics of the windows, according to an embodiment. In particular, FIGS. 5A to 5C illustrate an example of a process, performed by the electronic device, of combining the second window group, which is a combined multi-window having a horizontal-upper shape, with an additional window.

Referring to FIGS. 5A to 5C, a window 501 corresponds to the first window group of FIG. 2, a window 502 corresponds to the second window group of FIG. 2, and a window 505 corresponds to the third window group of FIG. 2. Decorators 511 and 519 correspond to the first decorator of FIG. 2, and decorators 512, 513, and 514 correspond to the second decorator of FIG. 2. The electronic device of FIGS. 5A to 5C may combine the first window group and the second window group according to the method disclosed in operations 210 to 240 of FIG. 2, wherein details redundant to those described in FIG. 2 will be understood by referring to FIG. 2, and a description thereof will be omitted.

Referring to FIG. 5A, in S510A, based on a location of the decorator 511 within the window 501 being at an upper end of the window 501, a shape of the window 502 being a horizontal-upper combination, a drop location of the decorator 511 being within a range of the decorator 512, and a location of the decorator 512 being at an upper end of the window 502, the electronic device may determine a shape of the combined multi-window 505 as a horizontal-upper combination, may determine a location of a unified decorator 515 to be at an upper end of the window 505, and may locate a plurality of individual decorators 516, 517, and 518 at lower ends of windows 503, 501, and 504, respectively.

The unified decorator 515 may be associated with all of the plurality of windows 501, 503, and 504 included in the window 505, and each of the plurality of individual decorators 516, 517, and 518 may be associated with a corresponding window among the plurality of windows 501, 503, and 504 included in the window 505.

According to an embodiment, the electronic device may identify, with respect to a certain range within the range of the second decorator, whether a drop location of the first decorator is included on a left side of the certain range, within the certain range, or on a right side of the certain range. The electronic device may determine, based on a result of the identifying, an arrangement of the third window group, that is, a layout/arrangement order of the plurality of windows included in the third window group.

Based on identifying that the drop location of the decorator 511 is included within a certain range 500 in the range of the decorator 512, the electronic device may determine an arrangement order of the plurality of windows 501, 503, and 504 included in the window 505 to be in the order of 503, 501, and 504.

Referring to FIG. 5B, in S510B, based on identifying that the drop location of the decorator 511 is included on a right side of the certain range 500 in the range of the decorator 512, the electronic device may determine the arrangement order of the plurality of windows 501, 503, and 504 included in the window 505 to be in the order of 503, 504, and 501.

Referring to FIG. 5C, in S520, based on a location of the decorator 519 corresponding to the window 501 within the window 501 being at the lower end of the window 501, the shape of the window 502 being a horizontal-upper combination, a drop location of the decorator 519 being within the range of the decorator 512, and the location of the decorator 512 being at the upper end of the window 502, the electronic device may determine the shape of the combined multi-window 505, may locate the unified decorator 515 at a center of the window 505, may locate the decorators 516 and 518 among the plurality of individual decorators at the lower ends of the windows 503 and 504, respectively, and may locate the decorator 517 among the plurality of individual decorators at the upper end of the window 501.

Based on identifying that the drop location of the decorator 519 is included within the certain range 500 in the range of the decorator 512, the electronic device may determine the arrangement order of the plurality of windows 501, 503, and 504 included in the window 505 to be in the order of 503, 501, and 504.

The unified decorator 515 may be associated with all of the plurality of windows 501, 503, and 504 included in the window 505, and each of the plurality of individual decorators 516, 517, and 518 may be associated with a corresponding window among the plurality of windows 501, 503, and 504 included in the window 505.

In a manner similar to the methods disclosed in FIGS. 5A to 5C, the electronic device may combine the second window group, which is a combined multi-window having a horizontal-lower shape, with an additional window.

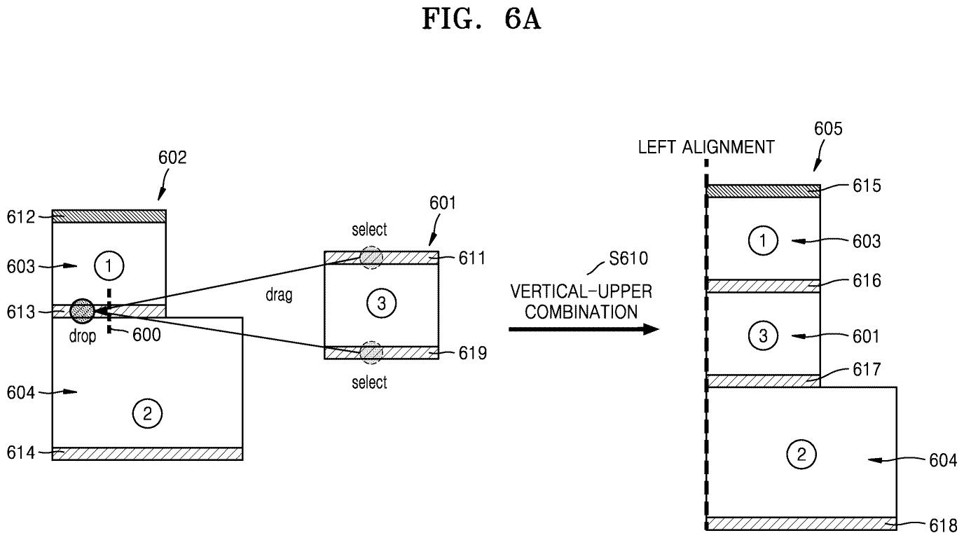

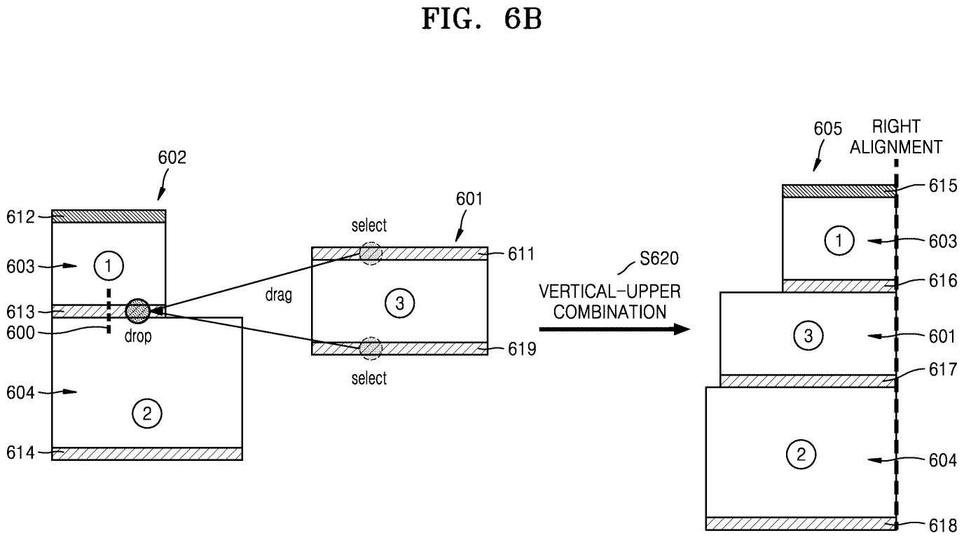

FIGS. 6A and 6B are each a diagram illustrating an example of a process, performed by an electronic device, of combining a combined multi-window with an additional window based on structural characteristics of the windows, according to an embodiment. In particular, FIGS. 6A and 6B illustrate an example of a process, performed by the electronic device, of combining the second window group, which is a combined multi-window having a vertical-upper shape, with an additional window.

Referring to FIGS. 6A and 6B, a window 601 corresponds to the first window group of FIG. 2, a window 602 corresponds to the second window group of FIG. 2, and a window 605 corresponds to the third window group of FIG. 2. Decorators 611 and 619 correspond to the first decorator of FIG. 2, and decorators 612, 613, and 614 correspond to the second decorator of FIG. 2. The electronic device of FIGS. 6A and 6B may combine the first window group and the second window group according to the method disclosed in operations 210 to 240 of FIG. 2, wherein details redundant to those described in FIG. 2 will be understood by referring to FIG. 2, and a description thereof will be omitted.

When a shape of the second window group is a vertical combination, the electronic device according to an embodiment may determine a shape of the third window group, regardless of a location of the first decorator corresponding to the first window group within the first window group.

Referring to FIG. 6A, in S610, because a shape of the window 602 is a vertical-upper combination, the electronic device may determine a shape of the combined multi-window 605 as a vertical-upper combination, regardless of whether a location of the decorator 611 corresponding to the window 601 within the window 601 is at an upper end or a lower end thereof.

Based on a drop location of the decorator 611 corresponding to the window 601 being within a range of the decorator 613, and a location of the decorator 612 being at an upper end of the window 602, the electronic device may determine the shape of the combined multi-window 605 as a vertical-upper combination, may locate a unified decorator 615 at an upper end of the window 605, and may locate a plurality of individual decorators 616, 617, and 618 at lower ends of windows 603, 601, and 604, respectively.

Even when detecting an input for selecting and dragging the decorator 619 located at the lower end of the window 601 and then dropping the decorator into the range of the decorator 613, the electronic device may similarly generate and display the window 605.

Based on identifying that the drop location of the decorator 611 is included on a left side of a central portion 600 within the range of the decorator 613, the electronic device may determine an arrangement of the plurality of windows 601, 603, and 604 included in the window 605 to be left-aligned.

The unified decorator 615 may be associated with all of the plurality of windows 601, 603, and 604 included in the window 605, and each of the plurality of individual decorators 616, 617, and 618 may be associated with a corresponding window among the plurality of windows 601, 603, and 604 included in the window 605.

Referring to FIG. 6B, in S620, based on identifying that the drop location of the decorator 611 is included on a right side of the central portion 600 within the range of the decorator 613, the electronic device may determine the arrangement of the plurality of windows 601, 603, and 604 included in the window 605 to be right-aligned.

In a manner similar to the methods disclosed in FIGS. 6A and 6B, the electronic device may combine the second window group, which is a combined multi-window having a vertical-lower shape, with an additional window.

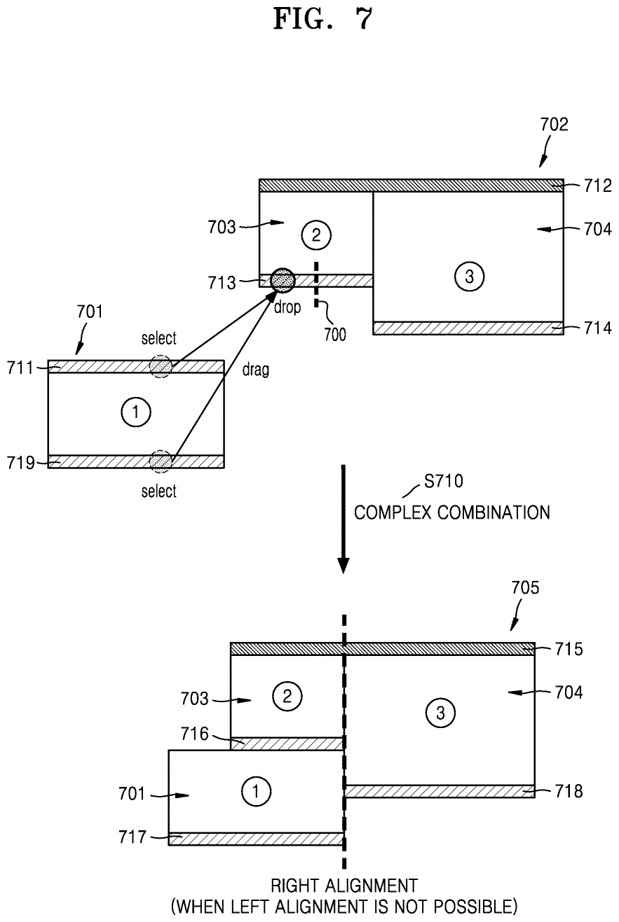

FIG. 7 is a diagram illustrating an example of a process, performed by an electronic device, of combining a combined multi-window with an additional window based on structural characteristics of the windows, according to an embodiment. In particular, FIG. 7 illustrates an example of a process, performed by the electronic device, of combining the second decorator corresponding to the second window group, which is an individual decorator, with an additional window.

Referring to FIG. 7, a window 701 corresponds to the first window group of FIG. 2, a window 702 corresponds to the second window group of FIG. 2, and a window 705 corresponds to the third window group of FIG. 2. Decorators 711 and 719 correspond to the first decorator of FIG. 2, and decorators 712, 713, and 714 correspond to the second decorator of FIG. 2. The electronic device of FIG. 7 may combine the first window group and the second window group according to the method disclosed in operations 210 to 240 of FIG. 2, wherein details redundant to those described in FIG. 2 will be understood by referring to FIG. 2, and a description thereof will be omitted.

The electronic device according to an embodiment may identify sizes of the plurality of windows included in the third window group, and, when determining that an overlap occurs in displaying the plurality of windows included in the third window group according to a determined shape/arrangement/layout, may determine an appropriate shape/arrangement/layout that is different from the determined shape/arrangement/layout.

In S710, based on a shape of the window 702 being a horizontal-upper combination, a drop location of the decorator 711 or 719 corresponding to the window 701 being within a range of the decorator 713, and a location of the decorator 712 being at an upper end of the window 702, the electronic device may determine a shape of the combined multi-window 705, may locate a unified decorator 715 at an upper end of the window 705, and may locate a plurality of individual decorators 716, 717, and 718 at lower ends of windows 703, 701, and 704, respectively.

The electronic device may identify that the drop location of the decorator 711 or 719 corresponding to the window 701 is included on a left side of a central portion 700 of the decorator 713. When left-aligning the window 701 and the window 703 based on a result of the identifying, the electronic device may determine that an overlap occurs between the window 701 and the window 704. In this case, the electronic device may determine right alignment of the window 701 and the window 703 as an appropriate arrangement/layout/shape.

The unified decorator 715 may be associated with all of the plurality of windows 701, 703, and 704 included in the window 705, and each of the plurality of individual decorators 716, 717, and 718 may be associated with a corresponding window among the plurality of windows 701, 703, and 704 included in the window 705.

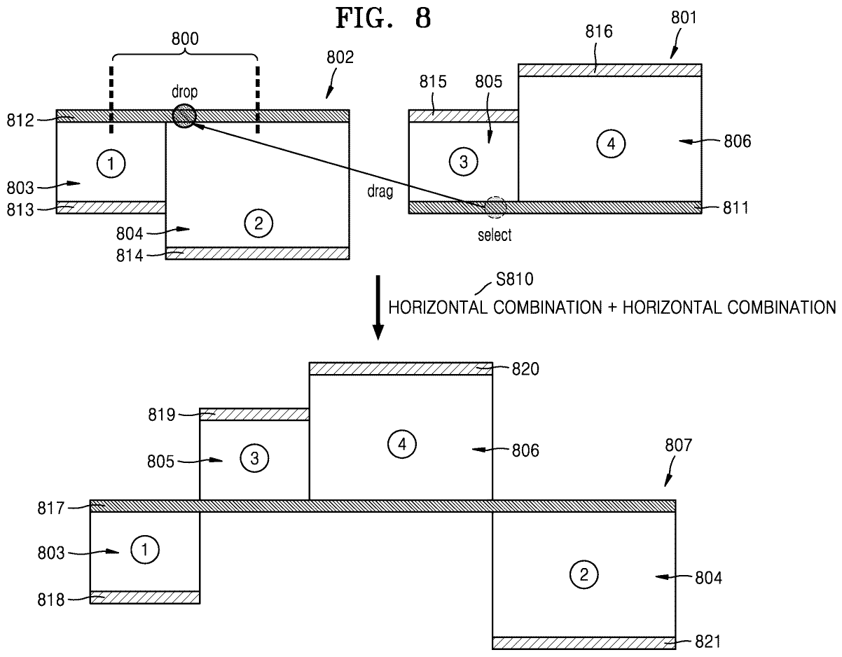

FIG. 8 is a diagram illustrating an example of a process, performed by an electronic device, of combining a combined multi-window with an additional combined multi-window based on structural characteristics of the windows, according to an embodiment. In particular, FIG. 8 illustrates an example of a process, performed by the electronic device, of combining multiple windows when the first window group has a horizontal-lower shape and the second window group has a horizontal-upper shape.

Referring to FIG. 8, a window 801 corresponds to the first window group of FIG. 2, a window 802 corresponds to the second window group of FIG. 2, and a window 807 corresponds to the third window group of FIG. 2. Decorators 811, 815, and 816 correspond to the first decorator of FIG. 2, and decorators 812, 813, and 814 correspond to the second decorator of FIG. 2. The electronic device of FIG. 8 may combine the first window group and the second window group according to the method disclosed in operations 210 to 240 of FIG. 2, wherein details redundant to those described in FIG. 2 will be understood by referring to FIG. 2, and a description thereof will be omitted.

In S810, based on a shape of the window 801 being a horizontal-lower combination, a location of the decorator 811 corresponding to the window 801 within the window 801 being at a lower end of the window 801, a shape of the window 802 being a horizontal-upper combination, a drop location of the decorator 811 being within a range of the decorator 812, and a location of the decorator 812 being at an upper end of the window 802, the electronic device may determine a shape of the combined multi-window 807, may locate a unified decorator 817 at a center of the window 807, may locate decorators 818 and 821 among a plurality of individual decorators at lower ends of windows 803 and 804, respectively, and may locate a plurality of individual decorators 819 and 820 at upper ends of windows 805 and 806.

Based on identifying that the drop location of the decorator 811 is within a certain range 800 in the range of the decorator 812, the electronic device may determine an arrangement order of the plurality of windows 803, 804, 805, and 806 included in the window 807 to be in the order of 803, 805, 806, and 804.

The unified decorator 817 may be associated with all of the plurality of windows 803, 804, 805, and 806 included in the window 807, and each of the plurality of individual decorators 818, 819, 820, and 821 may be associated with a corresponding window among the plurality of windows 803, 804, 805, and 806 included in the window 807.

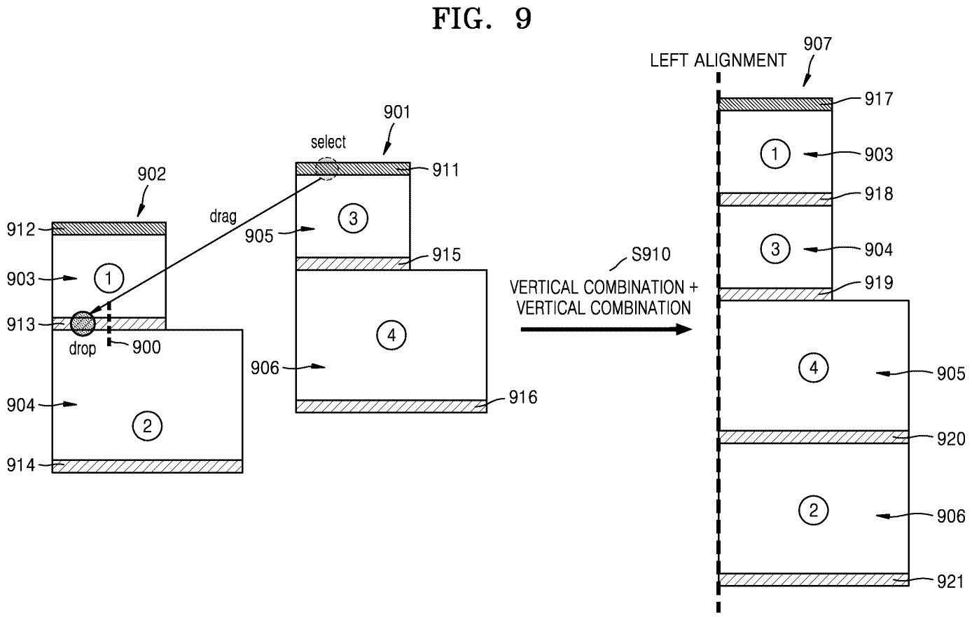

FIG. 9 is a diagram illustrating an example of a process, performed by an electronic device, of combining a combined multi-window with an additional combined multi-window based on structural characteristics of the windows, according to an embodiment. In particular, FIG. 9 illustrates an example of a process, performed by the electronic device, of combining multiple windows when the first window group has a vertical-upper shape and the second window group has a vertical-upper shape.

Referring to FIG. 9, a window 901 corresponds to the first window group of FIG. 2, a window 902 corresponds to the second window group of FIG. 2, and a window 907 corresponds to the third window group of FIG. 2. Decorators 911, 915, and 916 correspond to the first decorator of FIG. 2, and decorators 912, 913, and 914 correspond to the second decorator of FIG. 2. The electronic device of FIG. 9 may combine the first window group and the second window group according to the method disclosed in operations 210 to 240 of FIG. 2, wherein details redundant to those described in FIG. 2 will be understood by referring to FIG. 2, and a description thereof will be omitted.

In S910, based on a shape of the window 901 being a vertical-upper combination, a location of the decorator 911 corresponding to the window 901 within the window 901 being at an upper end of the window 901, a shape of the window 902 being a vertical-upper combination, a drop location of the decorator 911 being within a range of the decorator 913, a location of the decorator 913 being at a lower end of a window 903 included in the window 902, and a location of the decorator 912 being at an upper end of the window 902, the electronic device may determine a shape of the combined multi-window 907, may arrange the plurality of windows vertically in the order of 903, 904, 905, and 906, may locate a unified decorator 917 at an upper end of the window 907, and may locate a plurality of individual decorators 918, 919, 920, and 921 at lower ends of the windows 903, 904, 905, 906, respectively.

Based on identifying that the drop location of the decorator 911 is included on a left side of a central portion 900 within the range of the decorator 913, the electronic device may determine an arrangement of the plurality of windows 903, 904, 905, and 906 included in the window 907 to be left-aligned.

The unified decorator 917 may be associated with all of the plurality of windows 903, 904, 905, and 906 included in the window 907, and each of the plurality of individual decorators 918, 919, 920, and 921 may be associated with a corresponding window among the plurality of windows 903, 904, 905, and 906 included in the window 907.

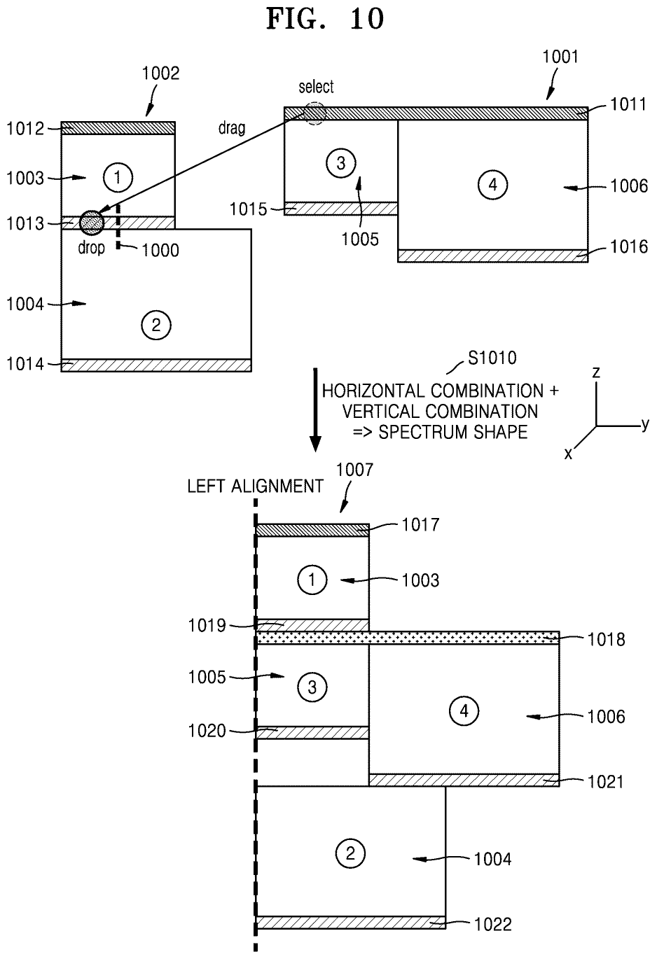

FIG. 10 is a diagram illustrating an example of a process, performed by an electronic device, of combining a combined multi-window with an additional combined multi-window based on structural characteristics of the windows, so as to form a spectrum structure, according to an embodiment. In particular, FIG. 10 illustrates an example of a process, performed by the electronic device, of combining multiple windows when the first window group has a horizontal-upper shape and the second window group has a vertical-upper shape.

Referring to FIG. 10, a window 1001 corresponds to the first window group of FIG. 2, a window 1002 corresponds to the second window group of FIG. 2, and a window 1007 corresponds to the third window group of FIG. 2. Decorators 1011, 1015, and 1016 correspond to the first decorator of FIG. 2, and decorators 1012, 1013, and 1014 correspond to the second decorator of FIG. 2. The electronic device of FIG. 10 may combine the first window group and the second window group according to the method disclosed in operations 210 to 240 of FIG. 2, wherein details redundant to those described in FIG. 2 will be understood by referring to FIG. 2, and a description thereof will be omitted.

According to an embodiment, the electronic device may form a spectrum combination when the first window group has a horizontal-upper shape and the second window group has a vertical-upper shape, or when the first window group has a vertical-upper shape and the second window group has a horizontal-upper shape. The spectrum combination is a combination formed when shapes of two multi-windows being combined are a horizontal combination and a vertical combination, respectively, and may refer to a combination in which two or more unified decorators are defined.

According to an embodiment, when there are two or more unified decorators, the electronic device may determine priorities of the two or more unified decorators according to predefined settings. The electronic device may determine the priorities based on relative locations of the two or more unified decorators within the display.

For example, the electronic device may determine a unified decorator located uppermost along a y-axis among the unified decorators to have the highest priority, and may determine the priorities to decrease progressively downward. For example, the electronic device may determine a unified decorator located leftmost along an x-axis among the unified decorators to have the highest priority, and may determine the priorities to decrease progressively rightward.

Each of the two or more unified decorators may be associated with a corresponding plurality of windows included in a third window group, according to the determined priorities. The electronic device may distinguish each unified decorator having a different priority in a visually recognizable manner, such as by color or pattern.

In S1010, based on a shape of the window 1001 being a horizontal-upper combination, a location of the decorator 1011 corresponding to the window 1001 within the window 1001 being at an upper end of the window 1001, a shape of the window 1002 being a vertical-upper combination, a drop location of the decorator 1011 being within a range of the decorator 1013, a location of the decorator 1013 being at a lower end of a window 1003 included in the window 1002, and a location of the decorator 1012 being at an upper end of the window 1002, the electronic device may determine a shape of the combined multi-window 1007 as a spectrum combination, may arrange a plurality of windows 1003, 1005, 1006, and 1004, may locate a unified decorator 1017 at the uppermost end, may locate a unified decorator 1018 at the second uppermost end, and may locate a plurality of individual decorators 1019, 1020, 1021, and 1022 at lower ends of the windows 1003, 1005, 1006, and 1004, respectively.

The electronic device may determine the unified decorator 1017, which is located uppermost along the y-axis among the unified decorators 1017 and 1018, to have the first priority, and may determine the unified decorator 1018, which is located therebelow, to have the second priority. The electronic device may distinguish each of the unified decorators 1017 and 1018 having different priorities in a visually recognizable manner, such as by color or pattern.

Based on identifying that the drop location of the decorator 1011 is included on a left side of a central portion 1000 within the range of the decorator 1013, the electronic device may determine an arrangement of the plurality of windows 1003, 1004, 1005, and 1006 included in the window 1007 to be left-aligned.

The first-priority unified decorator 1017 may be associated with all of the plurality of windows 1003, 1004, 1005, and 1006 included in the window 1007, the second-priority unified decorator 1018 may be associated with all of the plurality of windows 1005 and 1006 corresponding to the second-priority combination, and each of the plurality of individual decorators 1019, 1020, 1021, and 1022 may be associated with a corresponding window among the plurality of windows 1003,1004,1005, and 1006 included in the window 1007.

According to an embodiment, the electronic device may detect an input for selecting, dragging, and dropping a decorator corresponding to a first window group, and when a drop location of a first decorator is identified as being within a range of a second decorator corresponding to the first window group, the electronic device may generate a UI and temporarily display the UI on the display to allow the user to select a desired shape of a third window group.

The UI may include various applicable shapes of the third window group. The various applicable shapes of the third window group may include shapes that are determined to be applicable based on structural characteristics of windows, and may also include other shapes. In this case, the user may select a desired shape from among the shapes included in the UI. For example, the user may select a desired shape from among the horizontal-upper shape, the horizontal-lower shape, the vertical-upper shape, the vertical-lower shape, and the spectrum shape described in the present disclosure.

The electronic device may detect an input for selecting a shape of the third window group, and may determine the shape of the third window group based on the detected input. The electronic device may generate the third window group according to the determined shape of the third window group and display the third window group on the display.

According to an embodiment, the electronic device may preferentially determine the shape of the third window group based on preset conditions. The electronic device may generate the third window group according to the determined shape of the third window group and display the third window group on the display.

The preset conditions may refer to conditions installed during the manufacture of the electronic device, or conditions preset in the electronic device by the user. For example, when a type of the display is a horizontally long type, the electronic device may determine the shape of the third window group according to a condition that preferentially determines the shape of the third window group as a horizontal combination. For example, when the type of the display included in the electronic device is a vertically long type, the electronic device may determine the shape of the third window group according to a condition that preferentially determines the shape of the third window group as a vertical combination.

The combination shapes of multiple windows disclosed in the present disclosure are merely examples, and the electronic device according to an embodiment of the present disclosure may combine, by using a decorator, multiple windows in more various shapes that are not disclosed in the present disclosure.

According to an embodiment of the present disclosure, the electronic device may improve a user's experience of using a multi-window mode by providing a method of automatically combining multiple windows in various arrangements/combinations based on a drop location of a decorator or structural characteristics of each window corresponding to the decorator. Also, according to an embodiment of the present disclosure, the electronic device may improve the user's experience of using the multi-window mode by providing a UI that allows the user to select a desired combination shape of multiple windows, or by efficiently performing combination of multiple windows according to preset conditions.

The effects obtainable in the present disclosure are not limited to the above-mentioned effects, and other effects not mentioned may be clearly understood by one of ordinary skill in the art from the description below.

FIG. 11 is a diagram illustrating an example of a process, performed by an electronic device, of simply moving multiple windows without combining the windows, according to an embodiment. Referring to FIG. 11, a window 1101 corresponds to the first window group of FIG. 2, and a window 1102 corresponds to the second window group of FIG. 2. A decorator 1111 corresponds to the first decorator of FIG. 2, and decorators 1112, 1113, and 1114 correspond to the second decorator of FIG. 2.

According to an embodiment, when determining that a vector value of a point at which the first decorator 1111 is dropped is not included in a set of vector values indicating a range of the second decorator 1112, 1113, or 1114, the electronic device may identify that a drop location of the first decorator 1111 is outside the range of the second decorator 1112, 1113, or 1114 corresponding to the second window group 1102.

In S1110, when the drop location of the first decorator 1111 is identified as being outside the range of the second decorator 1112, 1113, or 1114, the electronic device may move the first window group 1101 to the drop location of the first decorator 1111, without combining the first window group 1101 and the second window group 1102.

According to an embodiment of the present disclosure, the electronic device may improve a user's experience of using a multi-window mode by providing a method of clearly distinguishing and controlling an operation desired by the user (whether to combine windows or to move windows) by not combining multiple windows when a drop location of a decorator is not in a range of another decorator.

The effects obtainable in the present disclosure are not limited to the above-mentioned effects, and other effects not mentioned may be clearly understood by one of ordinary skill in the art from the description below.

Hereinafter, a specific operation, performed by the electronic device according to an embodiment of the present disclosure, of controlling multiple windows that have been combined, either collectively or individually, by using decorators defined by the combination, will be described.

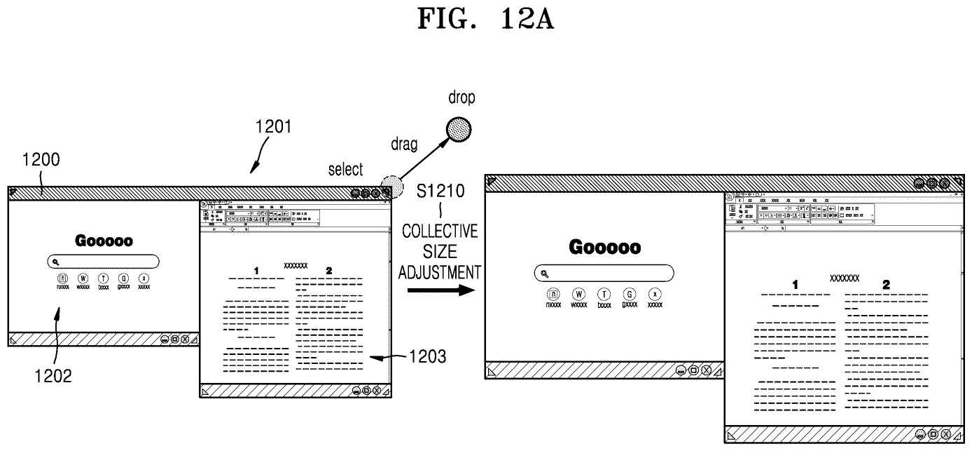

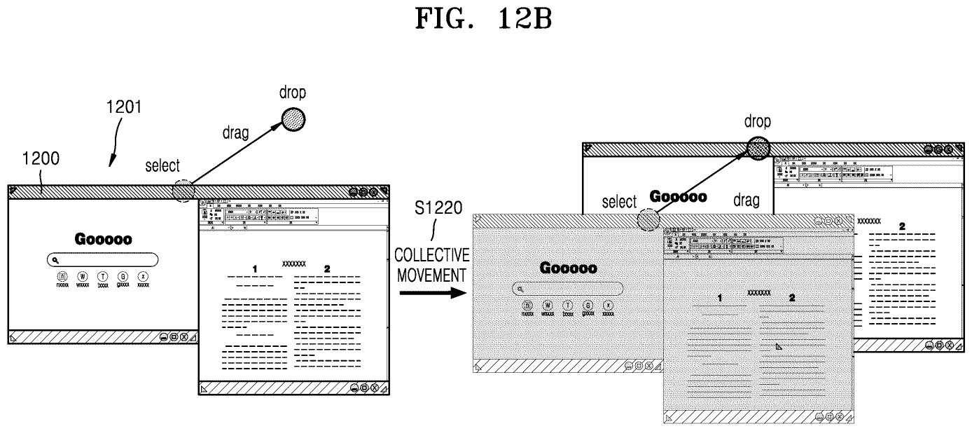

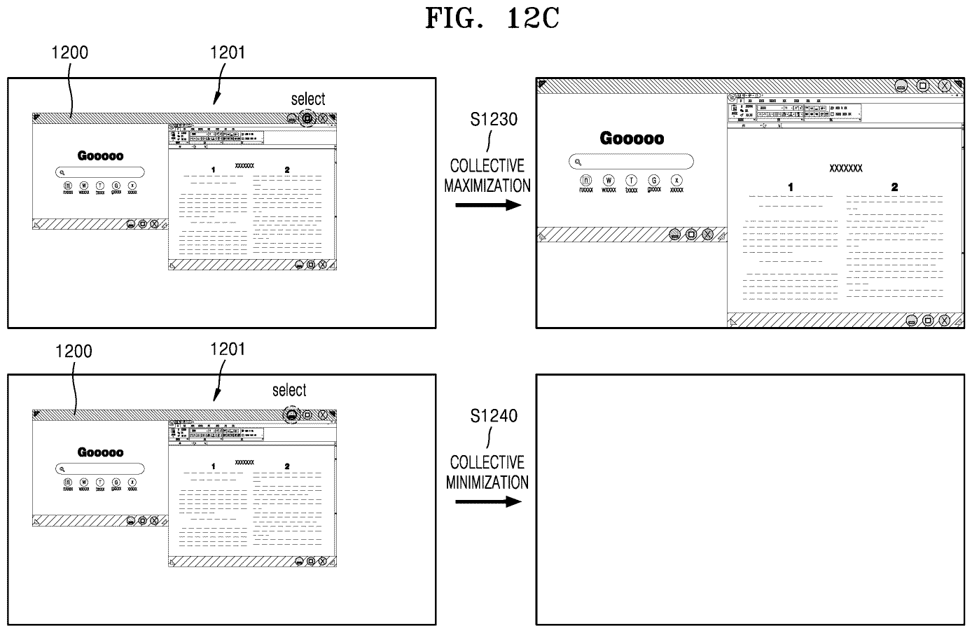

FIGS. 12A to 12C are each a diagram illustrating an example of a process, performed by an electronic device, of controlling a combined multi-window collectively, according to an embodiment.

Referring to FIGS. 12A to 12C, a window 1201 may correspond to the third window group of FIG. 2. To collectively control a plurality of windows 1202 and 1203 included in the combined multi-window 1201, a decorator 1200 is associated with all of the windows 1202 and 1203. The decorator 1200 may include one or more buttons or items for performing various functions to collectively control the plurality of windows 1202 and 1203 included in the window 1201.

Referring to FIG. 12A, in S1210, the electronic device may detect an input for selecting, dragging, and dropping some of resize buttons included in the decorator 1200. The electronic device may be configured to, in response to the input, perform an operation of reducing or increasing sizes of all of the plurality of windows 1202 and 1203 associated with the decorator 1200.

Referring to FIG. 12B, in S1220, the electronic device may detect an input for selecting, dragging, and dropping a point in a range of the decorator 1200. The electronic device may be configured to, in response to the input, perform an operation of moving all of the plurality of windows 1202 and 1203 associated with the decorator 1200.

Referring to FIG. 12C, in S1230, the electronic device may detect an input for selecting a maximize button included in the decorator 1200. The electronic device may be configured to, in response to the input, perform an operation of maximizing all of the plurality of windows 1202 and 1203 associated with the decorator 1200.

Referring to FIG. 12C, in S1240, the electronic device may detect an input for selecting a minimize button included in the decorator 1200. The electronic device may be configured to, in response to the input, perform an operation of minimizing all of the plurality of windows 1202 and 1203 associated with the decorator 1200.

According to an embodiment, the electronic device may detect an input for selecting a close button included in the decorator 1200. The electronic device may be configured to, in response to the input, perform an operation of terminating all applications corresponding to all of the plurality of windows 1202 and 1203 associated with the decorator 1200.

According to an embodiment, the electronic device may detect an input for selecting a save button included in the decorator 1200. The electronic device may be configured to, in response to the input, perform an operation of storing, in memory, all applications corresponding to all of the plurality of windows 1202 and 1203 associated with the decorator 1200.

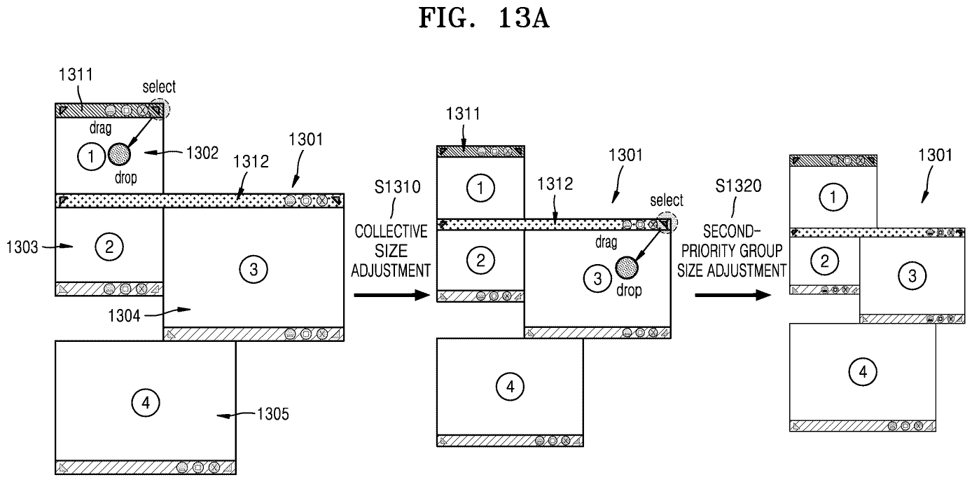

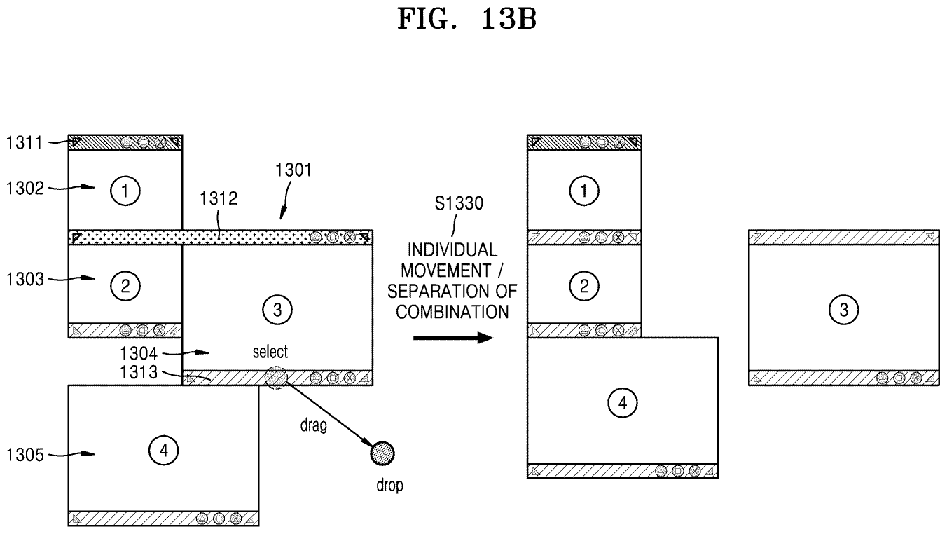

FIGS. 13A and 13B are each a diagram illustrating an example of a process, performed by an electronic device, of controlling a multi-window having a spectrum shape, according to an embodiment.

Referring to FIGS. 13A and 13B, a window 1301 may correspond to the third window group of FIG. 2, and in particular, may correspond to the window 1007 of FIG. 10. A decorator 1311 may correspond to a first-priority unified decorator (e.g., 1017 of FIG. 10). A decorator 1312 may correspond to a second-priority unified decorator (e.g., 1018 of FIG. 10).

To collectively control a plurality of windows 1302, 1303, 1304, and 1305 included in the combined multi-window 1301, the decorator 1311 is associated with all of the windows 1302, 1303, 1304, and 1305. The decorator 1311 may include one or more buttons or items for performing various functions to collectively control the plurality of windows 1302, 1303, 1304, and 1305.

To collectively control the plurality of windows 1303 and 1304 included in the second-priority combined multi-window, the decorator 1312 is associated with the windows 1303 and 1304, and is not associated with the windows 1302 and 1305. The decorator 1312 may include one or more buttons or items for performing various functions to collectively control the plurality of windows 1303 and 1304, which are combined with the second priority.

Referring to FIG. 13A, in S1310, the electronic device may detect an input for selecting, dragging, and dropping some of resize buttons included in the decorator 1311. The electronic device may be configured to, in response to the input, perform an operation of reducing or increasing sizes of all of the plurality of windows 1302, 1303, 1304, and 1305 included in the window 1301 associated with the decorator 1311.

In S1320, the electronic device may detect an input for selecting, dragging, and dropping some of resize buttons included in the decorator 1312. The electronic device may be configured to, in response to the input, perform an operation of reducing or increasing sizes of the plurality of windows 1303 and 1304 included in the second-priority group associated with the decorator 1312. In this case, the sizes of the windows 1302 and 1305, which are not associated with the decorator 1312, remain the same.

The electronic device may operate similarly to the above in other operations of controlling a multi-window having a spectrum structure (e.g., moving, minimizing, maximizing, closing, saving, etc.).

According to an embodiment, the electronic device may detect an input for selecting, dragging, and dropping one of the plurality of individual decorators. The electronic device may, in response to the input for selecting, dragging, and dropping one of the plurality of individual decorators, separate a window corresponding to the dragged and dropped individual decorator from the third window group. The electronic device may be configured to perform an operation of moving the separated window to a drop location of the individual decorator. In this case, the separated window is no longer associated with the unified decorator, and only the separated window may be released from the combination, while the combination of the remaining windows may remain the same.

Referring to FIG. 13B, in S1330, the electronic device may detect an input for selecting, dragging, and dropping a point within a range of an individual decorator 1313 corresponding to the window 1304. The electronic device may, in response to the input, separate the window 1304 corresponding to/associated with the decorator 1313 from the window 1301. The electronic device may move the separated window 1304 to a drop location of the decorator 1313. The separated window 1304 is no longer associated with the decorators 1311 and 1312, and only the separated window 1304 may be released from the combination, while the combination of the remaining windows 1302, 1303, and 1305 may remain the same.

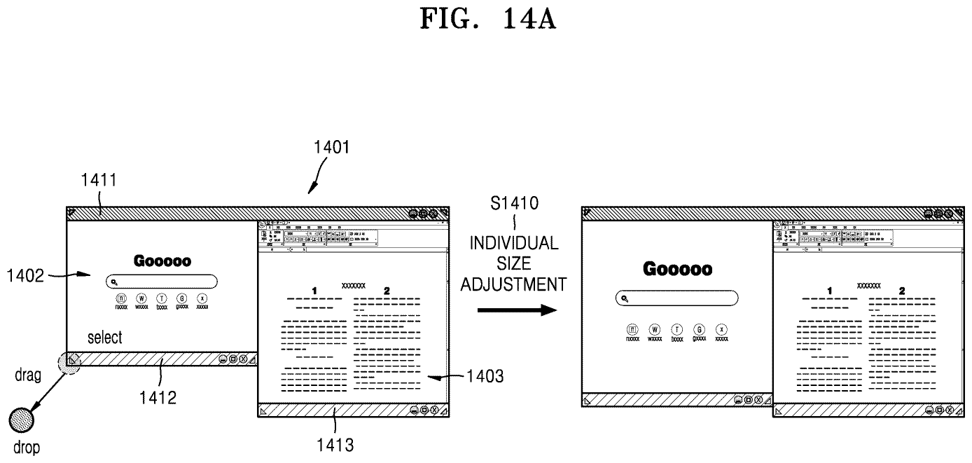

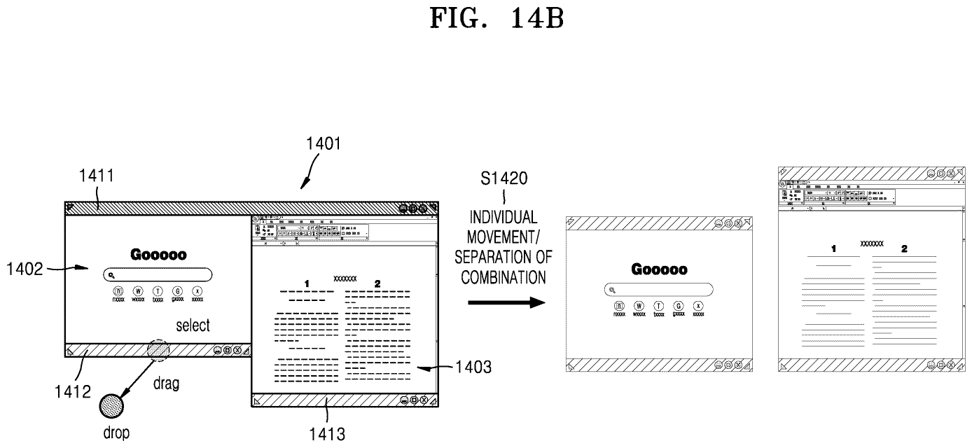

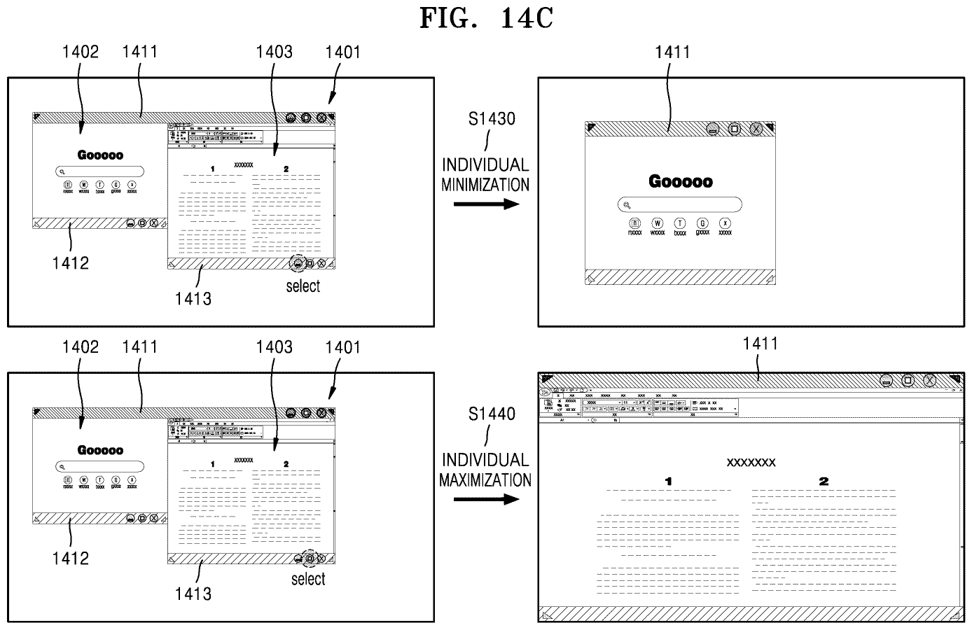

FIG. 14A to 14C are each a diagram illustrating an example of a process, performed by an electronic device, of individually controlling multiple windows that have been combined, according to an embodiment.

Referring to FIGS. 14A to 14C, a window 1401 may correspond to the third window group of FIG. 2. A decorator 1411 may correspond to the unified decorator of FIG. 2, and decorators 1412 and 1413 may correspond to the plurality of individual decorators of FIG. 2.

The decorator 1412 may include one or more buttons or items for performing various functions to individually control a window 1402. The decorator 1413 may include one or more buttons or items for performing various functions to individually control a window 1403.

To individually control the window 1402 included in the combined multi-window 1401, the decorator 1412 is associated with the window 1402, and is not associated with the window 1403. To individually control the window 1403 included in the combined multi-window 1401, the decorator 1413 is associated with the window 1403, and is not associated with the window 1402.

Referring to FIG. 14A, in S1410, the electronic device may detect an input for selecting, dragging, and dropping some of resize buttons included in the decorator 1412. The electronic device may be configured to, in response to the input, perform an operation of reducing or increasing a size of the window 1402 associated with the decorator 1412. In this case, a size of the window 1403, which is not associated with the decorator 1412, remains the same.

Referring to FIG. 14B, in S1420, the electronic device may detect an input for selecting, dragging, and dropping a point in a range of the decorator 1412. The electronic device may, in response to the input, separate the window 1402 corresponding to/associated with the decorator 1412 from the window 1401. The electronic device may be configured to perform an operation of moving the separated window 1402 to a drop location of the decorator 1412. The separated window 1402 is no longer associated with the decorator 1411, and the combination may be released.

Referring to FIG. 14C, in S1430, the electronic device may detect an input for selecting a minimize button included in the decorator 1413. The electronic device may be configured to, in response to the input, perform an operation of minimizing the window 1403 associated with the decorator 1413. In this case, the window 1402 that is not associated with the decorator 1413 may remain the same without being minimized, and the combination may also remain the same.

According to an embodiment, because the combination remains the same, when detecting an input for dragging and dropping the unified decorator 1411, or for selecting one or more buttons included in the unified decorator 1411, the electronic device may reflect, in the minimized window 1403, a control operation corresponding to the input associated with the unified decorator 1411.

Also, according to an embodiment, because the combination remains the same, when detecting an input for selecting a button corresponding to the window 1403 on a task bar, the electronic device may display the combined multi-window 1401 on the display. The task bar is a component that displays a list of windows currently in use or minimized windows. When the electronic device does not support a task bar function, the electronic device may generate and display a show-hidden-window button in the decorator 1411. The show-hidden-window button does not appear on the display, but may serve to indicate the presence of windows currently in use, and may perform the same function as the task bar.

In S1440, the electronic device may detect an input for selecting a maximize button included in the decorator 1413. The electronic device may be configured to, in response to the input, perform an operation of maximizing the window 1403 associated with the decorator 1413. According to the maximization of the window 1403, the window 1402 may enter a hidden-window mode, and the combination may remain the same. The hidden-window mode refers to a state in which a corresponding window does not appear on the display, and a window in the hidden window mode may be displayed via the task bar or the show-hidden-window button.

According to an embodiment, because the combination remains the same, when detecting an input for selecting a button corresponding to the window 1402 on the task bar, or an input for selecting the show-hidden-window button, the electronic device may display the combined multi-window 1401 in a maximized mode on the display.

According to an embodiment, the electronic device may detect an input for selecting a close button included in the decorator 1413. The electronic device may be configured to, in response to the input, perform an operation of terminating execution of an application corresponding to the window 1403 associated with the decorator 1413. In this case, the window 1402 that is not associated with the decorator 1413 may remain the same without execution thereof being terminated, and the combination may be released due to the termination of execution of the window 1403.

According to an embodiment, the electronic device may detect an input for selecting a save button included in the decorator 1413. The electronic device may be configured to, in response to the input, perform an operation of storing, in memory, an application corresponding to the window 1403 associated with the decorator 1413. In this case, an application corresponding to the window 1402, which is not associated with the decorator 1413, is not stored.

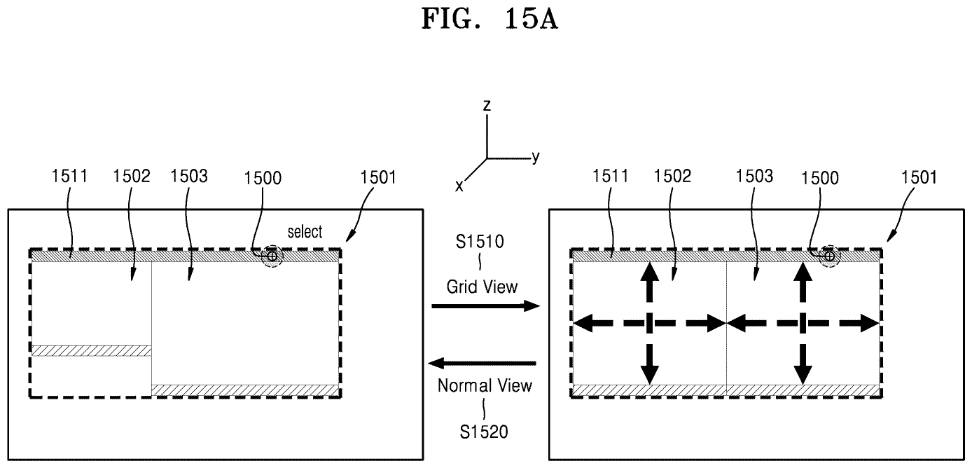

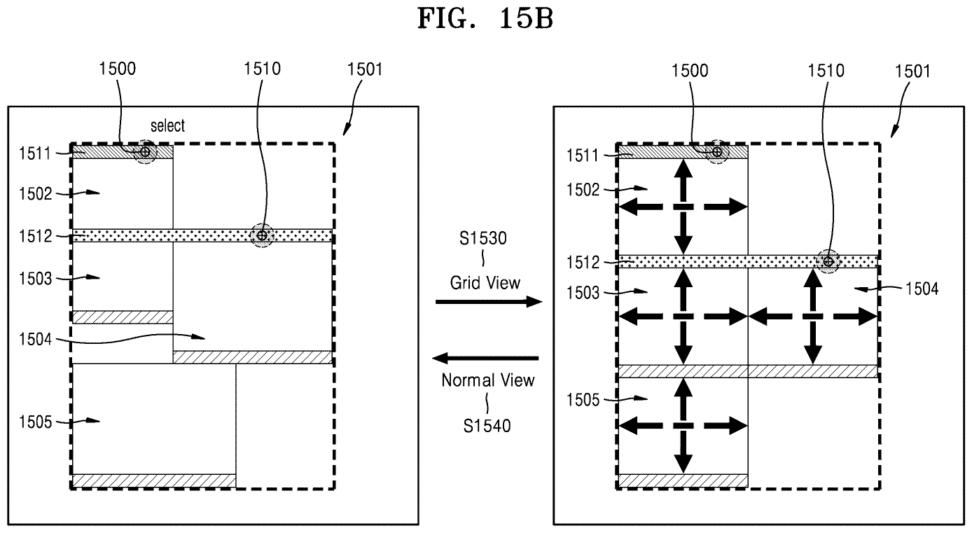

FIG. 15A is a diagram illustrating an example a process, performed by an electronic device, of controlling a combined multi-window by using a grid view button, according to an embodiment.

Referring to FIG. 15A, a window 1501 may correspond to the third window group of FIG. 2. A decorator 1511 may correspond to the unified decorator of FIG. 2, and, to collectively control a plurality of windows 1502 and 1503 included in the window 1501, is associated with all of the windows 1502 and 1503.

A grid view button 1500 is a button for the electronic device to perform a function of adjusting all of the plurality of windows included in the combined multi-window to the same size. The electronic device according to an embodiment may be configured to perform an operation of adjusting all of the plurality of windows included in the combined multi-window to the same size, based on the largest width of the combined multi-window in each of an x-axis direction, a y-axis direction, and a z-axis direction. When the electronic device performs a grid view function, the grid view button 1500 may be switched to a normal view button 1500. The normal view button 1500 is a button for the electronic device to perform a function of adjusting sizes of the plurality of windows to sizes thereof before the grid view function was activated. The grid view button 1500 and the normal view button 1500 may be included in the unified decorator to collectively control all of the plurality of windows included in the third window group after the third window group is generated.

In S1510, the electronic device may detect an input for selecting the grid view button 1500 included in the decorator 1511 corresponding to 1501. The electronic device may be configured to, in response to the input, perform an operation of adjusting all of the plurality of windows 1502 and 1503 included in the combined multi-window 1501 to the same size, based on the largest width of the combined multi-window 1501 in each of the x-axis direction, the y-axis direction, and the z-axis direction.

In S1520, the electronic device may detect an input for selecting the normal view button 1500 included in the decorator 1511 corresponding to the window 1501. The electronic device may be configured to, in response to the input, perform an operation of adjusting all of the plurality of windows 1502 and 1503 included in the combined multi-window 1501 to respective sizes thereof before the grid view function was activated.

FIG. 15B is a diagram illustrating an example a process, performed by an electronic device, of controlling a combined multi-window having a spectrum structure by using a grid view button, according to an embodiment. Details redundant to those described in FIG. 15A will be understood by referring to FIG. 15A, and a description thereof will be omitted.

Referring to FIG. 15B, the window 1501 may correspond to a third window group (e.g., 1007 of FIG. 10) having a spectrum structure. The decorator 1511 may correspond to a first-priority unified decorator (e.g., 1017 of FIG. 10). A decorator 1512 may correspond to a second-priority unified decorator (e.g., 1018 of FIG. 10).

To collectively control a plurality of windows 1502, 1503, 1504, and 1505 included in the window 1501, the decorator 1511 is associated with all of the windows 1502, 1503, 1504, and 1505. To collectively control the plurality of windows 1503 and 1504 that are combined with the second priority, the decorator 1512 is associated with the windows 1503 and 1504, and is not associated with the windows 1502 and 1505.

In S1530, the electronic device may detect an input for selecting the grid view button 1500 included in the first-priority unified decorator 1511 corresponding to the combined multi-window 1501. The electronic device may be configured to, in response to the input, perform an operation of adjusting all of the plurality of windows 1502, 1503, 1504, and 1505 included in the combined multi-window 1501 to the same size, based on the largest width of the combined multi-window 1501 in each of the x-axis direction, the y-axis direction, and the z-axis direction.

The electronic device may detect an input for selecting a grid view button 1510 included in the second-priority unified decorator 1512 corresponding to the second-priority combined multi-window. The electronic device may be configured to, in response to the input, perform an operation of adjusting all of the plurality of windows 1503 and 1504, which are combined with the second priority, to the same size, based on the largest width of the second-priority group multi-window in each of the x-axis direction, the y-axis direction, and the z-axis direction. In this case, the windows 1502 and 1505, which are not associated with the second-priority unified decorator 1512, may remain the same without being adjusted to the same size.

In S1540, the electronic device may detect an input for selecting the normal view button 1500 included in the decorator 1511 corresponding to the combined multi-window 1501. The electronic device may be configured to, in response to the input, perform an operation of adjusting all of the plurality of windows 1502, 1503, 1504, and 1505 included in the combined multi-window 1501 to respective sizes thereof before the grid view function was activated.

The electronic device may detect an input for selecting a normal view button 1510 included in the second-priority unified decorator 1512 corresponding to the second-priority group multi-window. The electronic device may be configured to, in response to the input, perform an operation of adjusting the plurality of windows 1503 and 1504, which are combined with the second priority, to respective sizes thereof before the grid view function was activated. In this case, the windows 1502 and 1505, which are not associated with the second-priority unified decorator 1512, may remain the same without being adjusted in size.

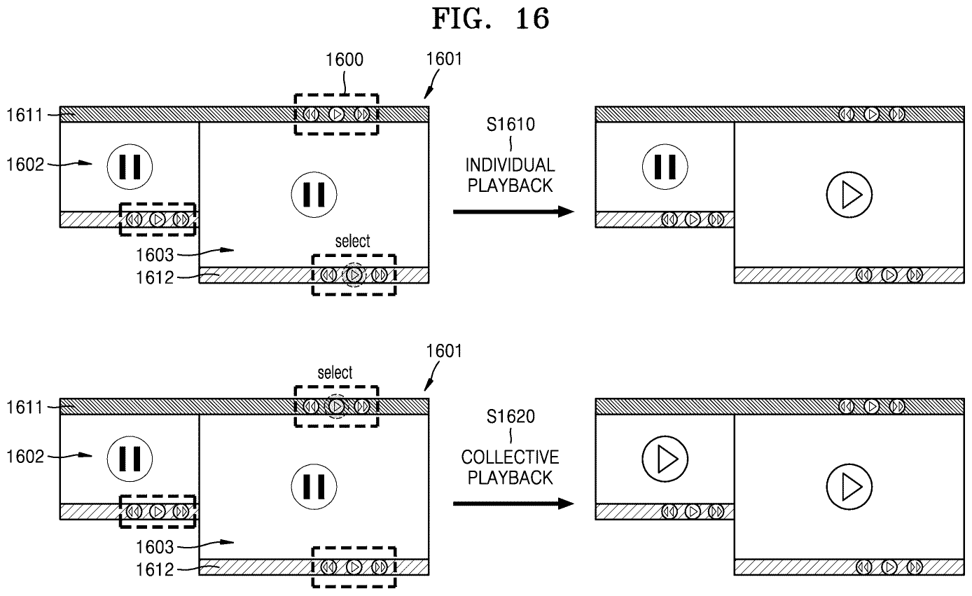

FIG. 16 is a diagram illustrating an example a process, performed by an electronic device, of controlling a combined multi-window by using a playback button, according to an embodiment.

Referring to FIG. 16, a window 1601 may correspond to the third window group of FIG. 2.

A decorator 1611 corresponds to the unified decorator of FIG. 2, and, to collectively control a plurality of windows 1602 and 1603 included in the window 1601, is associated with all of the windows 1602 and 1603. A decorator 1612 corresponds to one of the plurality of individual decorators of FIG. 2, and, to individually control the window 1603 included in the combined multi-window 1601, is associated with the window 1603 and is not associated with the window 1602.

A playback button 1600 is a button for the electronic device to perform a function of controlling playback when applications corresponding to all of the plurality of windows included in the combined multi-window include playable content. The playback button 1600 may support not only starting playback, but also pausing, skipping, and rewinding content currently being played back.

The playable content may include audio content or image content. The ‘audio content’ refers to content including auditory elements, and may represent content including sound signals within the audible frequency range. The ‘image content’ refers to content including not only auditory elements but also visual elements, and may represent a still image, a picture, a frame, a moving image including a plurality of consecutive still images, or a video.

The playback button 1600 may be included in a unified decorator and a plurality of individual decorators corresponding to/associated with the combined multi-window.

In S1610, the electronic device may detect an input for selecting a playback button included in the decorator 1612. The electronic device may be configured to, in response to the input, perform an operation of playing back playable content in an application corresponding to the window 1603 associated with the decorator 1612. In this case, the window 1602, which is not associated with the decorator 1612, remains the same without being played back.

In S1620, the electronic device may detect an input for selecting a playback button included in the decorator 1611. The electronic device may be configured to, in response to the input, perform an operation of playing back all playable content in applications respectively corresponding to the plurality of windows 1602 and 1603 included in the decorator 1611.

The electronic device may operate similarly to the above in pausing, skipping, and rewinding the content currently being played back, by using the playback button 1600 included in a decorator.

The operations of controlling a multi-window by using a decorator disclosed in the present disclosure are merely examples, and the electronic device according to an embodiment of the present disclosure may control a multi-window by using a decorator in more various operations that are not disclosed in the present disclosure.

According to an embodiment of the present disclosure, the electronic device may improve a user's experience of using a multi-window mode by providing a method of controlling multiple windows that have been combined, either collectively or individually in the combined state, and then separating the combination, by using decorators defined by the combination. The effects obtainable in the present disclosure are not limited to the above-mentioned effects, and other effects not mentioned may be clearly understood by one of ordinary skill in the art from the description below.

Hereinafter, examples of a method, performed by the electronic device according to an embodiment of the present disclosure, of perform the above-described operations by using a multi-processing function will be described.

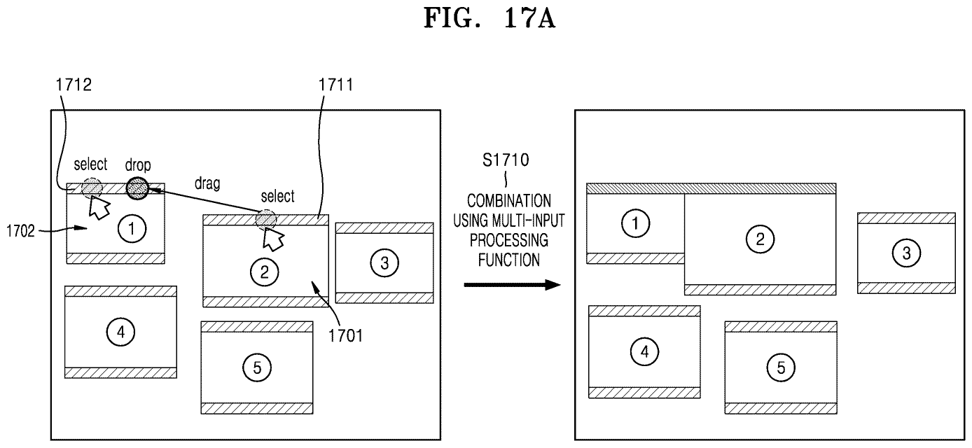

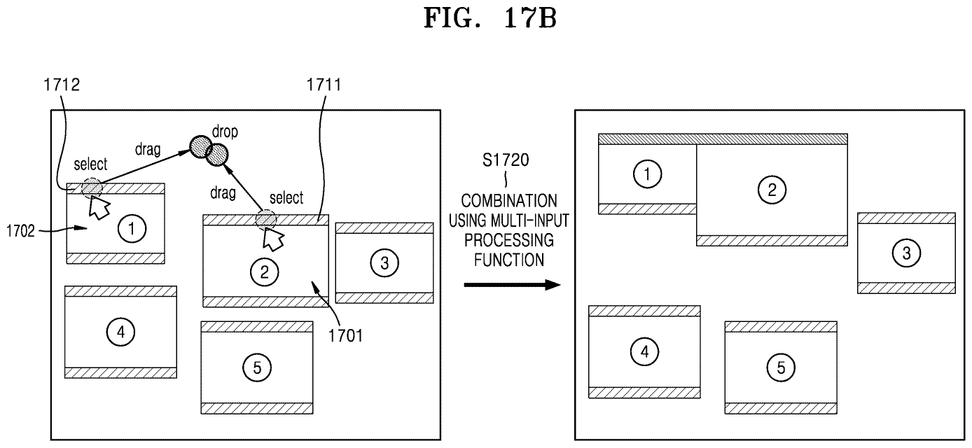

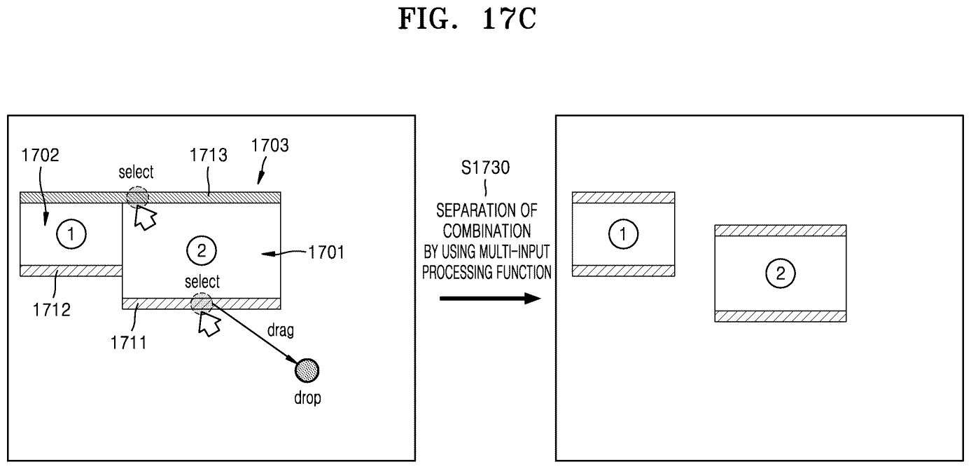

FIGS. 17A and 17B are each a diagram illustrating an example of a process, performed by an electronic device supporting a multi-input processing function, of combining multiple windows, according to an embodiment.

According to an embodiment, the electronic device may support a multi-input processing function for combining a plurality of windows or controlling a plurality of combined windows. The multi-input processing function refers to a function that allows the electronic device to simultaneously process a plurality of input signals detected through an input interface.

Referring to FIGS. 17A and 17B, a window 1701 may correspond to the first window group of FIG. 2, and a window 1702 may correspond to the second window group of FIG. 2. A decorator 1711 may correspond to the first decorator of FIG. 2, and a decorator 1712 may correspond to the second decorator of FIG. 2.

Referring to FIG. 17A, in S1710, the electronic device may detect an input for selecting the decorator 1712 corresponding to the window 1702. The electronic device may detect an input for selecting and dragging the decorator 1711 corresponding to the window 1701. By using the multi-input processing function, the electronic device may detect the two inputs simultaneously or within a very short time interval, and may process the two inputs simultaneously.

Thereafter, according to operations 220 to 240 of FIG. 2, the electronic device may combine the first window group 1701 and the second window group 1702. Details redundant to those described in FIG. 2 will be understood by referring to FIG. 2, and a description thereof will be omitted.

Referring to FIG. 17B, in S1720, the electronic device may detect an input for selecting, dragging, and dropping the decorator 1712 corresponding to the window 1702. The electronic device may detect an input for selecting, dragging, and dropping the decorator 1711 corresponding to the window 1701. By using the multi-input processing function, the electronic device may detect the two inputs simultaneously or within a very short time interval, and may process the two inputs simultaneously.

The electronic device may identify a drop location of the decorator 1712 and a drop location of the decorator 1711, and, when the drop locations are within a certain error range, may combine the window 1701 and the window 1702 according to operation 240 of FIG. 2. Details redundant to those described in FIG. 2 will be understood by referring to FIG. 2, and a description thereof will be omitted.

FIG. 17C is a diagram illustrating an example of a process, performed by an electronic device supporting a multi-input processing function, of separating a combined multi-window, according to an embodiment.

Referring to FIG. 17C, a window 1703 may correspond to the third window group. A decorator 1713 is a unified decorator, and, to collectively control the plurality of windows 1701 and 1702 included in the window 1703, may be associated with/correspond to all of the windows 1701 and 1702. The decorator 1711 is an individual decorator, and, to individually control the window 1701 included in the window 1703, may be associated with/correspond to the window 1701.

In S1730, the electronic device may detect an input for selecting the decorator 1713 corresponding to the window 1703. The electronic device may detect an input for selecting, dragging, and dropping a point within a range of the decorator 1711 corresponding to the window 1701 included in the window 1703.

By using the multi-input processing function, the electronic device may detect the two inputs simultaneously or within a very short time interval, and may process the two inputs simultaneously.

Afterwards, the electronic device may separate the combination of multi-windows according to S1420 of FIG. 14B. Details redundant to those described in FIG. 14B will be understood by referring to FIG. 14B, and a description thereof will be omitted.

According to an embodiment of the present disclosure, the electronic device may improve a user's experience of using a multi-window mode by providing a method of controlling multiple windows that have been combined, either collectively or individually in the combined state, by using decorators defined by the combination. The effects obtainable in the present disclosure are not limited to the above-mentioned effects, and other effects not mentioned may be clearly understood by one of ordinary skill in the art from the description below.

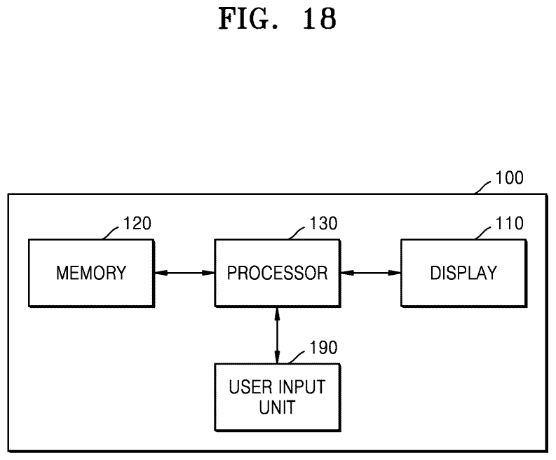

FIG. 18 is a block diagram of an electronic device according to an embodiment.

Referring to FIG. 18, an electronic device 100 according to an embodiment may include a display 110, memory 120, at least one processor 130, and a user input unit 190. However, the electronic device 100 may be implemented with more components than the illustrated components, and is not limited to the example described above. Hereinafter, the components will be sequentially described.

The display 110 may display data processed in the electronic device 100. When the display 110 is implemented as a touch screen, the display 110 may be used as an input device in addition to an output device. For example, the display 110 may include at least one of a liquid crystal display, a thin film transistor-liquid crystal display, an organic light-emitting diode, a flexible display, a 3D display, or an electrophoretic display.

The user input unit 190 is an interface for receiving a user input, and may receive a touch input by using a touch sensitive element. The user input may include a touch input from a user's finger, a palm touch input, and an electronic pen input. Also, the user input may include an input from a general physical brush. In this case, the user may have an experience similar to painting on an actual canvas by using a brush. According to an embodiment, the user input unit 190 may include a touch sensitive element for measuring a pressure of a detected touch input.

The memory 120 may store a program for the at least one processor 130 to perform processing and control, and may store data input to or output from the electronic device 100.

The memory 120 may include at least one type of storage medium among a flash memory type, a hard disk type, a multimedia card micro type, card type memory (e.g., SD or XD memory), random access memory (RAM), static random access memory (SRAM), read-only memory (ROM), electrically erasable programmable read-only memory (EEPROM), programmable read-only memory (PROM), magnetic memory, a magnetic disk, and an optical disk.

According to an embodiment, the memory 120 may include one or more instructions for performing functions of combining multiple windows and controlling the combined multi-window as disclosed in the present disclosure.

The at least one processor 130 controls the overall operation of the electronic device 100. For example, the at least one processor 130 may control the display 110 by executing the one or more instructions stored in the memory 120, and may perform the functions of the electronic device described in FIGS. 1 to 17C.

The processor 130 may include one or more processors. In this case, the one or more processors may include a general-purpose processor such as a CPU, an AP, or a digital signal processor (DSP), a graphics-dedicated processor such as a GPU or a vision processing unit (VPU), or an artificial intelligence-dedicated processor such as an NPU. For example, when the one or more processors include an artificial intelligence-dedicated processor, the artificial intelligence-dedicated processor may be designed with a hardware structure specialized for processing a specific artificial intelligence model.

In an embodiment, the at least one processor 130 may detect an input for selecting, dragging, and dropping a first decorator corresponding to a first window group including at least one window. The at least one processor 130 may identify whether a drop location of the first decorator, which indicates a location at which the first decorator is dropped, is within a range of a second decorator corresponding to a second window group including at least one window. When the drop location of the first decorator is identified as being within the range of the second decorator, the at least one processor 130 may generate and display, based on at least one of the drop location of the first decorator, structural characteristics of the at least one window included in the first window group, and structural characteristics of the at least one window included in the second window group, a third window group in which the first window group and the second window group are combined. The at least one processor 130 may define and display a unified decorator for collectively controlling a plurality of windows included in the third window group, and a plurality of individual decorators for individually controlling the plurality of windows included in the third window group.

In an embodiment, the unified decorator may include one or more items for collectively controlling the plurality of windows included in the third window group. The unified decorator may be associated with all of the plurality of windows included in the third window group. Each of the plurality of individual decorators may include one or more items for individually controlling the plurality of windows included in the third window group. Each of the plurality of individual decorators may be associated with a corresponding window among the plurality of windows included in the third window group.

In an embodiment, structural characteristics of the first window group may include a location of the first decorator within the first window group. The location of the first decorator within the first window group may be either at an upper end or a lower end of the first window group. Structural characteristics of the second window group may include a location of the second decorator within the second window group. The location of the second decorator within the second window group may be either at an upper end or a lower end of the second window group. The at least one processor 130 may determine, depending on whether the location of the first decorator within the first window group is at the upper end or the lower end, and on whether the location of the second decorator within the second window group is at the upper end or the lower end, a shape of the third window group, a location of the unified decorator, and locations of the plurality of individual decorators.

In an embodiment, the at least one processor 130 may identify whether the drop location of the first decorator is included on a left side or a right side of a central portion within the range of the second decorator. The at least one processor 130 may determine, based on a result of the identifying, an arrangement of the plurality of windows included in the third window group.

In an embodiment, when there are two or more unified decorators for collectively controlling the plurality of windows included in the third window group, the at least one processor 130 may determine priorities of the two or more unified decorators according to predefined settings. The two or more decorators may be respectively associated with a corresponding plurality of windows included in the third window group, according to the determined priorities.

In an embodiment, the at least one processor 130 may detect an input for selecting, dragging, and dropping one of the plurality of individual decorators. The at least one processor 130 may, in response to the input for selecting, dragging, and dropping one of the plurality of individual decorators, separate a window corresponding to the dragged and dropped individual decorator from the third window group.

In an embodiment, when the drop location of the first decorator is identified as being outside the range of the second decorator, the at least one processor 130 may move the first window group to the drop location of the first decorator, without combining the first window group and the second window group.

In an embodiment, the at least one processor 130 may support a multi-input processing function for combining a plurality of windows or controlling a plurality of combined windows.

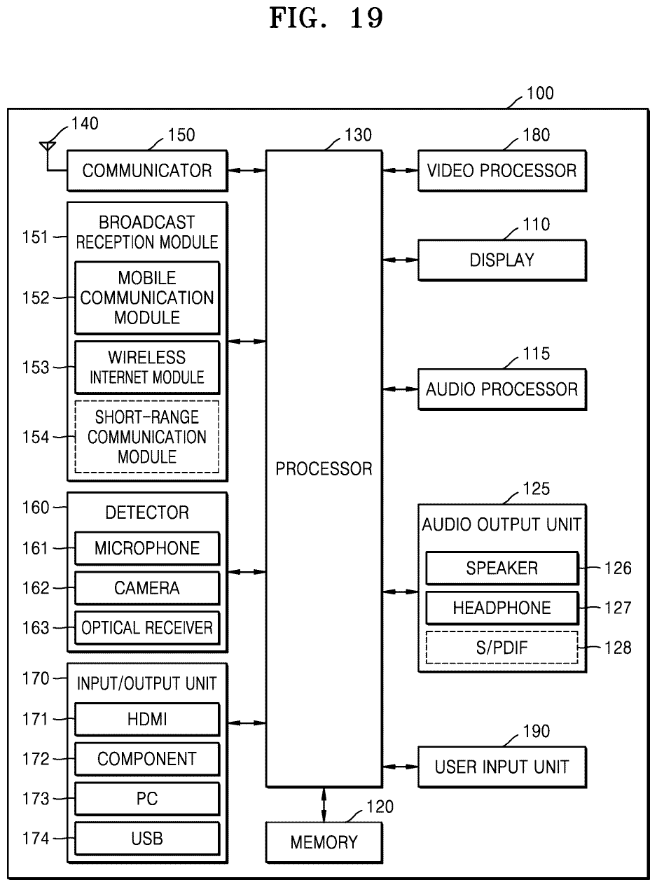

FIG. 19 is a block diagram of an electronic device according to an embodiment.

As illustrated in FIG. 19, the electronic device 100 may further include a video processor 180, an audio processor 115, an audio output unit 125, a tuner 140, a communicator 150, a detector 160, and an input/output unit 170, in addition to the display 110, the memory 120, the processor 130, and the input unit 190.

Regarding the display 110, the memory 120, the processor 130, and the user input unit 190, details redundant to those described in FIG. 18 will be omitted in FIG. 19.

The tuner 140 may select and tune only the frequency of a channel to be received by the electronic device 100, among numerous radio wave components, through amplification, mixing, or resonance of broadcast signals that are received by wire or wirelessly. The broadcast signals include audio, video, and additional information (e.g., an electronic program guide (EPG)).

The communicator 150 may connect the electronic device 100 to an external device (e.g., an audio device, a mobile device, etc.) under the control by the processor 130. The processor 130 may transmit/receive content to/from the external device connected via the communicator 150, may download an application from the external device, or may browse the web.

The communicator 150 may include one or more modules that enable wireless communication between the electronic device 100 and a wireless communication system, or between the electronic device 100 and a network in which other electronic devices are located. For example, the communicator 150 may include a broadcast reception module 151, a mobile communication module 152, a wireless Internet module 153, and a short-range communication module 154. The communicator 150 may be referred to as a transmitter/receiver.

The broadcast reception module 151 receives a broadcast signal and/or broadcast-related information from an external broadcast management server through a broadcast channel. The broadcast signal may include not only a TV broadcast signal, a radio broadcast signal, and a data broadcast signal, but also a broadcast signal in which a data broadcast signal is combined with a TV broadcast signal or a radio broadcast signal.

The mobile communication module 152 transmits and receives a wireless signal to and from at least one of a base station, an external terminal, and a server, on a mobile communication network. The wireless signal may include a voice call signal, a video call signal, or various types of data according to text/multimedia message transmission and reception.

The wireless Internet module 153 refers to a module for wireless Internet access, and may be built into or external to the device. Wireless Internet technologies that may be used include wireless LAN (WLAN) (WiFi), wireless broadband (Wibro), World Interoperability for Microwave Access (Wimax), and High Speed Downlink Packet Access (HSDPA). Through the wireless Internet module 153, the device may establish a Wi-Fi connection with other devices. For example, the processor 130 may communicate with one or more APs by using the wireless Internet module 153.

The short-range communication module 154 refers to a module for short-range communication. Short-range communication technologies that may be used include Bluetooth, Radio Frequency Identification (RFID), infrared communication (Infrared Data Association (IrDA)), Ultra Wideband (UWB), and ZigBee.

The detector 160 detects a user's voice, a user's image, or a user's interaction, and may include a microphone 161, a camera 162, and an optical receiver 163.

The microphone 161 receives a user's uttered voice. The microphone 161 may convert the received voice into an electrical signal and output the electrical signal to the processor 130.

The camera 162 may receive an image (e.g., consecutive frames) corresponding to a user's motion, including a gesture, within a camera recognition range.

The optical receiver 163 receives an optical signal (including a control signal) received from a remote control device. The optical receiver 163 may receive an optical signal corresponding to a user input (e.g., touch, press, touch gesture, voice, or motion) from the control device. A control signal may be extracted from the received optical signal under the control by the processor 130.

The input/output unit 170 receives video (e.g., a moving image, etc.), audio (e.g., voice, music, etc.), and additional information (e.g., an EPG, etc.) from outside the electronic device 100 under the control by the processor 130. The input/output unit 170 may include one of a High-Definition Multimedia Interface (HDMI) port 171, a component jack 172, a PC port 173, and a USB port 174, or a combination thereof.

The video processor 180 processes image data to be displayed by the display 110, and may perform various video processing operations, such as decoding, rendering, scaling, noise filtering, frame rate conversion, and resolution conversion, on the image data.

The display 110 may display video included in a broadcast signal received through the tuner 140, under the control by the processor 130. Also, the display 110 may display content (e.g., a moving image) input through the communicator 150 or the input/output unit 170. The display 110 may output an image stored in the memory 120, under the control by the processor 130.

Meanwhile, when the display 110 and a touch pad form a layer structure to constitute a touch screen, the display 110 may be used as an input device in addition to an output device. The display 110 may include at least one of a liquid crystal display, a thin film transistor-liquid crystal display, an organic light-emitting diode, a flexible display, a 3D display, or an electrophoretic display.

The audio processor 115 performs processing on audio data. The audio processor 115 may perform various processing such as decoding, amplification, and noise filtering on the audio data.

The audio output unit 125 may output audio included in a broadcast signal received through the tuner unit 140, audio input through the communicator 150 or the input/output unit 170, or audio stored in the memory 120, under the control by the processor 130. The audio output unit 125 may include at least one of a speaker 126, a headphone output terminal 127, or a Sony/Philips Digital Interface (S/PDIF) output terminal 128.

The user input unit 190 refers to a means by which a user inputs data for controlling the electronic device 100. The user input unit 190 may include a touch input unit that receives a touch input. For example, the user input unit 190 may include a key pad, a dome switch, a touch pad (a touch capacitance type, a pressure-resistive film type, an infrared detection type, a surface ultrasonic conduction type, an integral strain gauge type, a piezoelectric effect type, etc.), a jog wheel, or a jog switch, but is not limited thereto.

The memory 120 according to an embodiment may store a program for the processor 130 to perform processing and control, and may store data input to or output from the electronic device 100.

The processor 130 controls the overall operation of the electronic device 100 and the flow of signals between internal components of the electronic device 100, and performs a function of processing data. When there is a user input or when preset and stored conditions are satisfied, the processor 130 may execute an operating system (OS) and various applications stored in the memory 120. Also, according to an embodiment, the processor 130 may execute the one or more instructions stored in the memory 120, which implement functions of combining and controlling multiple windows.

Meanwhile, the block diagrams of the electronic device 100 illustrated in FIGS. 18 and 19 are block diagrams for an embodiment. Respective components of the block diagrams may be unified, added, or omitted depending on specifications of the electronic device 100 to be actually implemented. For example, two or more components may be combined into one component, or one component may be subdivided into two or more components, as needed. Also, functions performed by respective blocks are merely illustrative of embodiments, and specific operations or devices thereof do not limit the scope of the present disclosure.

A specific example illustrating an embodiment according to the present disclosure is merely a combination of respective criteria, methods, detailed methods, and operations, and the electronic device 100 may improve a user's experience by providing a method of controlling a multi-window through a combination of at least two or more of the various techniques described herein. Also, in this case, the method may be performed according to a manner determined through one of, or a combination of at least two of the above-described techniques. For example, some of operations of an embodiment may be performed in combination with some of operations of another embodiment.

A machine-readable storage medium may be provided in the form of a non-transitory storage medium. Here, the ‘non-transitory storage medium’ refers to a tangible device and does not include a signal (e.g., an electromagnetic wave), and the term does not distinguish between a case where data is stored in the storage medium semi-permanently and a case where data is stored in the storage medium temporarily. For example, the ‘non-transitory storage medium’ may include a buffer in which data is temporarily stored.

According to an embodiment, the method according to various embodiments disclosed herein may be included in a computer program product and then provided. The computer program product may be a commercial product that may be traded between a seller and a buyer. The computer program product may be distributed in the form of a machine-readable storage medium (e.g., compact disc read only memory (CD-ROM), or may be distributed online (e.g., downloaded or uploaded) through an application store or directly between two user devices (e.g., smartphones). In the case of online distribution, at least a portion of the computer program product (e.g., a downloadable application) may be temporarily stored in a machine-readable storage medium, such as a memory of a manufacturer's server, an application store's server, or a relay server, or may be temporarily generated.

1. An electronic device, comprising:
a display;
an input interface;
a memory to store one or more instructions; and
at least one processor configured to execute the one or more instructions stored in the memory to cause the electronic device to:
detect an input, received through the input interface, for selecting, dragging, and dropping a first decorator corresponding to a first window group including at least one window,
identify whether a drop location of the first decorator, which indicates a location at which the first decorator is dropped, is within a range of a second decorator corresponding to a second window group including at least one window,
according to the drop location of the first decorator being identified as being within the range of the second decorator, generate and display a third window group in which the first window group and the second window group are combined in an arrangement relative to each other based on at least one of the drop location of the first decorator, structural characteristics of the at least one window included in the first window group, or structural characteristics of the at least one window included in the second window group, and
define and display a unified decorator configured to collectively control a plurality of windows including the at least one window of the first window group and the at least one window of the second window group included in the third window group, and a plurality of individual decorators configured to individually control the plurality of windows included in the third window group.

2. The electronic device of claim 1, wherein the unified decorator includes one or more items configured to collectively control the plurality of windows included in the third window group, and is associated with all of the plurality of windows included in the third window group, and
the plurality of individual decorators respectively include one or more items configured to individually control the plurality of windows included in the third window group, and are respectively associated with a corresponding window among the plurality of windows included in the third window group.

3. The electronic device of claim 1, wherein the structural characteristics of the at least one window included in the first window group include a location of the first decorator within the first window group,
the location of the first decorator within the first window group is either at an upper end or a lower end of the first window group,
the structural characteristics of the at least one window included in the second window group include a location of the second decorator within the second window group,
the location of the second decorator within the second window group is either at an upper end or a lower end of the second window group, and
the at least one processor executes the one or more instructions to cause the electronic device to:
determine, depending on whether the location of the first decorator within the first window group is at the upper end or the lower end, and depending on whether the location of the second decorator within the second window group is at the upper end or the lower end, a shape of the third window group, a location of the unified decorator, and locations of the plurality of individual decorators.

4. The electronic device of claim 1, wherein the at least one processor (130) executes the one or more instructions to cause the electronic device to:
identify whether the drop location of the first decorator is included on a left side or a right side of a central portion within the range of the second decorator, and
determine, based on a result of the identifying, an arrangement of the plurality of windows included in the third window group.

5. The electronic device of claim 1, wherein the at least one processor executes the one or more instructions to cause the electronic device to:
based on there being two or more unified decorators, determine priorities of the two or more unified decorators according to predefined settings,
wherein the two or more unified decorators are respectively associated with a corresponding plurality of windows, according to the determined priorities.

6. The electronic device of claim 1, wherein the at least one processor executes the one or more instructions to cause the electronic device to:
detect an input for selecting, dragging, and dropping one individual decorator of the plurality of individual decorators, and
based on the input for selecting, dragging, and dropping the one individual decorator of the plurality of individual decorators, separate a window corresponding to the one individual decorator, from the third window group.

7. The electronic device of claim 1, wherein the at least one processor executes the one or more instructions to cause the electronic device to:
based on the drop location of the first decorator being identified as being outside the range of the second decorator, move the first window group to the drop location of the first decorator, without combining the first window group and the second window group.

8. The electronic device of claim 1, wherein the electronic device is configured to support a multi-input processing function to combine a plurality of windows or control a plurality of combined windows.

9. An operation method of an electronic device, the operation method comprising:
detecting an input for selecting, dragging, and dropping a first decorator corresponding to a first window group including at least one window;
identifying whether a drop location of the first decorator, which indicates a location at which the first decorator is dropped, is within a range of a second decorator corresponding to a second window group including at least one window;
according to the drop location of the first decorator being identified as being within the range of the second decorator, generating and displaying a third window group in which the first window group and the second window group are combined in an arrangement relative to each other based on at least one of the drop location of the first decorator, structural characteristics of the at least one window included in the first window group, or structural characteristics of the at least one window included in the second window group; and
defining and displaying a unified decorator configured to collectively control a plurality of windows including the at least one window of the first window group and the at least one window of the second window group included in the third window group, and a plurality of individual decorators configured to individually control the plurality of windows included in the third window group.

10. The operation method of claim 9, wherein the unified decorator includes one or more items configured to collectively control the plurality of windows included in the third window group, and is associated with all of the plurality of windows included in the third window group, and
the plurality of individual decorators respectively include one or more items configured to individually control the plurality of windows included in the third window group, and is associated with a corresponding window among the plurality of windows included in the third window group.

11. The operation method of claim 9, wherein the structural characteristics of the at least one window included in the first window group include a location of the first decorator within the first window group,
the location of the first decorator within the first window group is either at an upper end or a lower end of the first window group,
the structural characteristics of the at least one window included in the second window group include a location of the second decorator within the second window group,
the location of the second decorator within the second window group is either at an upper end or a lower end of the second window group, and
the method further comprising:
determining, depending on whether the location of the first decorator within the first window group is at the upper end or the lower end, and on whether the location of the second decorator within the second window group is at the upper end or the lower end, a shape of the third window group, a location of the unified decorator, and locations of the plurality of individual decorators.

12. The operation method of claim 9, further comprising:
identifying whether the drop location of the first decorator is included on a left side or a right side of a central portion within the range of the second decorator; and
determining, based on a result of the identifying, an arrangement of the plurality of windows included in the third window group.

13. The operation method of claim 9, further comprising:
based on there being two or more unified decorators, determining priorities of the two or more unified decorators according to predefined settings,
wherein the two or more unified decorators are respectively associated with a corresponding plurality of windows, according to the determined priorities.

14. The operation method of claim 9, further comprising:
detecting an input for selecting, dragging, and dropping one individual decorator of the plurality of individual decorators; and
based on the input for selecting, dragging, and dropping the one individual decorator of the plurality of individual decorators, separating a window corresponding to the one individual decorator, from the third window group.

15. The operation method of claim 9, further comprising:
based on the drop location of the first decorator being identified as being outside the range of the second decorator, moving the first window group to the drop location of the first decorator, without combining the first window group and the second window group.

16. The operation method of claim 9, wherein the electronic device is configured to support a multi-input processing function to combine a plurality of windows or control a plurality of combined windows.

17. A non-transitory computer-readable recording medium having recorded thereon at least one program to implement the operation method of claim 9.
